(19) United States
(12) Patent Application Publication
(10) Pub. No.: US 2026/0329783 A1
(43) Pub. Date: Oct. 22, 2026

(54) MULTI-TARGET DATA WRITING METHOD

(71) Applicant: NOREL SYSTEMS LIMITED, Tianjin (CN)

(72) Inventors: Yuanlong WANG, Tianjin (CN); Hui WANG, Tianjin (CN)

(21) Appl. No.: 19/691,775

(22) Filed: May 29, 2026

Related U.S. Application Data
(63) Continuation of application No. PCT/CN2025/099070, filed on Jun. 4, 2025.

(30) Foreign Application Priority Data
Aug. 8, 2024 (CN) 202411086909.3

(51) Int. Cl. G06F 13/16; G06F 13/42

(52) U.S. Cl. CPC G06F 13/1615; G06F 13/4291

(57) ABSTRACT

The present invention provides a multi-target data writing method based on an interface system, where the interface system includes a master controller, an interface module and a plurality of functional modules; the master controller is connected to the interface module, and the interface module is connected to the plurality of functional modules. Based on the interface system, the present invention proposes a method for high-speed data transmission, which enables a single I2C interface or a single SPI interface to perform parallel data transmission to multiple target devices, and the selection of multiple target devices can be configured.

### CROSS-REFERENCE TO RELATED APPLICATION

This application is a continuation application of International Patent Application No. PCT/CN 2025/099070, filed on Jun. 4, 2025, which itself claims priority to and benefit of Chinese Patent Application No. 202411086909.3, filed on Aug. 8, 2024 in the State Intellectual Property Office of P. R. China. The disclosure of each of the above applications is incorporated herein by reference in its entirety.

### TECHNICAL FIELD

The present invention relates to the technical field of communications, in particular to an interface system and a multi-target data writing method.

### BACKGROUND ART

The I2C bus is a simple, bidirectional serial bus developed by Philips Company. A device interconnected via the I2C bus is referred to as an I2C device, and an interface through which an I2C device accesses the I2C bus is referred to as an I2C interface. The I2C bus has become a de facto international standard, and the design specification of the I2C bus and its protocol (referred to as the standard I2C specification) is generally based on the description in the document *THE I2C-BUS SPECIFICATION VERSION 2.1 JANUARY 2000*.

An I2C interface includes an I2C clock line (generally named SCL) and an I2C data line (generally named SDA). An I2C master controller is connected to one or more I2C slave devices via the I2C clock line and the I2C data line, drives the I2C clock line, initiates an I2C write operation or a read operation, and judges whether data transmission is successful through an acknowledgment bit. Bit errors occurring on the bus due to signal interference and other reasons cannot be identified by the I2C slave devices.

The electrical characteristics of the I2C interface require that devices participating in I2C communication be “common-grounded”, otherwise transmission cannot be realized. Therefore, I2C communication is not suitable for application scenarios with long transmission distances or large signal interference. To solve this problem, a device for forwarding I2C data is usually added to the I2C bus, but the introduction of a forwarding device brings new problems:

The communication mechanism of I2C requires that the I2C slave device return an acknowledgment bit for each byte sent by the I2C master controller; a low-level acknowledgment bit is an I2C ACK, and a high-level acknowledgment bit is an I2C NAK. In the prior art, each byte sent by the I2C master controller is transmitted to the final data receiving module (referred to as a functional module in the present invention), and the functional module generates an acknowledgment bit and returns it to the I2C master controller, resulting in a slow acknowledgment speed of the transmission system and thus a low transmission speed.

SPI (Serial Peripheral Interface) is a high-speed, full-duplex, synchronous communication bus that occupies only four pins on a chip, saving chip pins and providing convenience for PCB layout. SPI usually has four signal lines, including an SPI_CSN signal line, an SPI_CK signal line, an SPI_MOSI signal line and an SPI_MISO signal line. An SPI master controller is connected to an SPI interface module via these four signal lines, where the SPI master controller serves as an SPI master device and the SPI interface module serves as an SPI slave device. The SPI master controller drives the SPI_CSN signal line, the SPI_CK signal line and the SPI_MOSI signal line, the SPI interface module receives the SPI_CSN signal line, the SPI_CK signal line and the SPI_MOSI signal line, the SPI interface module drives the SPI_MISO signal line, and the SPI master controller receives the SPI_MISO signal line. The SPI interface module receives and samples data driven by the SPI master controller on the SPI_MOSI signal line at the rising edge or falling edge of the SPI_CK signal line, and the SPI master controller receives and samples data driven by the SPI interface module on the SPI_MISO signal line at the rising edge or falling edge of the SPI_CK signal line. In the SPI protocol, the SPI master controller drives the SPI_CK signal line and generates clock edges on the SPI_CK signal line, and the SPI master controller and the SPI interface module sample data on the SPI_MISO signal line and the SPI_MOSI signal line at the clock rising edges or falling edges on the SPI_CK signal line to realize bidirectional data transmission between the SPI master controller and the SPI interface module. The SPI_CSN signal line is a selection signal; in the SPI protocol, data transmission is performed only when the SPI_CSN signal line is low. One SPI master controller can be connected to multiple SPI interface modules, that is, one SPI master device can be connected to multiple SPI slave devices, where the SPI master controller and the multiple SPI interface modules share the SPI_CK signal line, the SPI_MOSI signal line and the SPI_MISO signal line, but each SPI interface module has an independent SPI_CSN signal line input. When the SPI_CSN signal line of an SPI interface module is high, the SPI interface module does not drive the SPI_MISO signal line (the driver of the SPI interface module connected to the SPI_MISO signal line outputs a Hi-Z state), and an SPI interface module drives the SPI_MISO signal line only when its SPI_CSN signal line is low. When one SPI master controller is connected to multiple SPI interface modules, only the SPI_CSN signal line of one SPI interface module is low at any time, thus avoiding conflicts caused by multiple SPI interface modules driving the SPI_MISO signal line simultaneously.

When one SPI master controller is connected to only one SPI interface module, the SPI interface module can drive the SPI_MISO signal line at any time without causing conflicts. In this case, there may be no SPI_CSN signal line between the SPI master controller and the SPI interface module, that is, when one SPI master controller is connected to only one SPI interface module, the SPI master controller and the SPI interface module can be connected only via the SPI_CK signal line, the SPI_MOSI signal line and the SPI_MISO signal line.

For long-distance data transmission, the mode of sending a command packet and then receiving a feedback packet is generally adopted, where the feedback packet contains status information of command execution, and for a read command, the feedback packet can also contain read data. In the existing SPI protocol, bidirectional data transmission between the SPI master controller and the SPI interface module is realized by sampling data on the SPI_MISO signal line and the SPI_MOSI signal line at the clock rising edges or falling edges on the SPI_CK signal line, but such data transmission can be regarded as a kind of data stream transmission, which is not suitable for long-distance data transmission. In the prior art, whether for the existing I2C protocol or SPI protocol, a single I2C interface or SPI interface generally only supports data transmission to a single target device at a time. Although I2C has the broadcasting capability, broadcasting is directed to all devices connected to the I2C bus, and target devices cannot be selected. Currently, the market needs a data transmission method with high speed, which enables a single I2C interface or a single SPI interface to perform parallel data transmission to multiple target devices, and the selection of multiple target devices can be configured.

### SUMMARY

The present invention provides a data transmission method with high speed, which enables a single I2C interface or a single SPI interface to perform parallel data transmission to multiple target devices, and the selection of multiple target devices can be configured. An objective of the present invention is to provide a multi-target data writing method based on an interface system, where the interface system includes a master controller, an interface module and a plurality of functional modules, the master controller is connected to the interface module, and the interface module is connected to the plurality of functional modules. The method is characterized in that:

The master controller sends a write command packet to the interface module, and after receiving the write command packet, the interface module sends the write command packet to one or more functional modules;
the functional modules receiving the write command packet execute one or more write commands contained in the write command packet and return a write status packet to the interface module, including:
when the execution result of each write command contained in the write command packet is successful, the functional module returns a write status packet with successful status information to the interface module;
when the execution result of at least one write command contained in the write command packet is failed, the functional module returns a write status packet with failed status information to the interface module;
the interface module receives the write status packet from each functional module to which it sends the write command packet, and returns the status information of the write status packet to the master controller.

Preferably, the master controller is an I2C master controller, and the interface module is an I2C interface module;
the I2C master controller is connected to the I2C interface module via an I2C clock line and an I2C data line, initiates an I2C write operation to send the write command packet to the I2C interface module, and after receiving the write command packet, the I2C interface module pulls down the level of the I2C clock line and sends the write command packet to one or more functional modules;
the functional modules receiving the write command packet return the write status packet to the I2C interface module, and the I2C interface module receives the write status packet from each functional module to which it sends the write command packet and returns the status information of the write status packet to the I2C master controller.

Further, when the I2C interface module receives the write status packet from each functional module to which it sends the write command packet and the status information of each write status packet is successful, the I2C interface module stops pulling down the level of the I2C clock line and returns an I2C ACK to the I2C master controller; when the I2C interface module receives the write status packet from each functional module to which it sends the write command packet and the status information of at least one write status packet is failed, the I2C interface module stops pulling down the level of the I2C clock line and returns an I2C NAK to the I2C master controller.

Further, after the I2C interface module receives the write status packet from each functional module to which it sends the write command packet, the I2C interface module stops pulling down the level of the I2C clock line and returns an I2C ACK or an I2C NAK to the I2C master controller;
if a subsequent I2C operation initiated by the I2C master controller is an I2C read operation, the I2C interface module returns the status information of the write status packet to the I2C master controller.

Preferably, the master controller is an I2C master controller, and the interface module is an I2C interface module;
the I2C master controller is connected to the I2C interface module via an I2C clock line and an I2C data line, initiates an I2C write operation to send the write command packet to the I2C interface module, and after receiving the write command packet, the I2C interface module sends the write command packet to one or more functional modules; the functional modules receiving the write command packet return the write status packet to the I2C interface module;
after the I2C interface module receives the write command packet:
if a subsequent I2C operation initiated by the I2C master controller is an I2C read operation, and the I2C interface module receives the write status packet from each functional module to which it sends the write command packet, the I2C interface module returns the status information of the write status packet to the I2C master controller.

Further, if the subsequent I2C operation initiated by the I2C master controller is an I2C write operation:
if the I2C interface module receives the write status packet from each functional module to which it sends the write command packet and the status information of each write status packet is successful, the I2C interface module receives the subsequent I2C write operation initiated by the I2C master controller;
if the I2C interface module receives the write status packet from each functional module to which it sends the write command packet and the status information of at least one write status packet is failed, the I2C interface module returns an I2C NAK to the I2C master controller.

Preferably, the master controller is an SPI master controller, and the interface module is an SPI interface module; the SPI master controller is connected to the SPI interface module via an SPI_CK signal line, an SPI_MOSI signal line and an SPI_MISO signal line; the SPI master controller generates clock edges on the SPI_CK signal line and sends the write command packet to the SPI interface module via the SPI_MOSI signal line, where the write command packet starts with a first identifier; after receiving the write command packet from the SPI_MOSI, the SPI interface module sends the write command packet to one or more functional modules;
the functional modules receiving the write command packet return the write status packet to the SPI interface module; the SPI interface module receives the write status packet from each functional module to which it sends the write command packet and returns the status information of the write status packet to the SPI master controller, including: after receiving the write status packet from each functional module to which it sends the write command packet, the SPI interface module sends a write feedback packet to the SPI master controller via the SPI_MISO signal line when the SPI master controller generates a clock edge on the SPI_CK, where the write feedback packet starts with a second identifier and contains the status information of the write status packet.

Further, the SPI master controller generates clock edges on the SPI_CK signal line and reads the write feedback packet via the SPI_MISO signal line; if the SPI interface module does not receive the write status packet from each functional module to which it sends the write command packet, the SPI interface module sends data that cannot be identified as the write feedback packet to the SPI master controller via the SPI_MISO signal line.

Further, the SPI master controller generates clock edges on the SPI_CK signal line and sends the write command packet to the SPI interface module via the SPI_MOSI signal line; then the SPI master controller generates clock edges on the SPI_CK signal line and reads the write feedback packet via the SPI_MISO signal line; after sending the write feedback packet via the SPI_MISO signal line, the SPI interface module can continue to receive subsequent command packets.

Further, the write feedback packet is divided into a write success feedback packet and a write failure feedback packet;
the SPI master controller generates clock edges on the SPI_CK signal line and reads the write feedback packet via the SPI_MISO signal line;
when the SPI interface module receives the write status packet from each functional module to which it sends the write command packet and the status information of each write status packet is successful, the SPI interface module sends the write success feedback packet via the SPI_MISO signal line, where the write success feedback packet starts with a third identifier;
when the SPI interface module receives the write status packet from each functional module to which it sends the write command packet and the status information of at least one write status packet is failed, the SPI interface module sends the write failure feedback packet via the SPI_MISO signal line, where the write failure feedback packet starts with a fourth identifier.

Preferably, the functional module receiving the write command packet is connected to a remote I2C slave device; after receiving the write command packet from the interface module, the functional module receiving the write command packet executes one or more write commands contained in the write command packet, and the method for executing each write command is as follows:
the functional module sends an I2C START to the remote I2C slave device, then sends a remote I2C address byte to the remote I2C slave device, and then sends a write command to the remote I2C slave device;
for each byte sent by the functional module to the remote I2C slave device, the functional module receives an I2C acknowledgment bit sent by the remote I2C slave device and determines the execution result of the write command.

Further, the functional module receiving the write command packet includes a remote I2C address register, and the I2C address contained in the remote I2C address byte sent by the functional module receiving the write command packet to the remote I2C slave device is the remote I2C address stored in the remote I2C address register.

Further, the write command packet contains a remote I2C address, and the I2C address contained in the remote I2C address byte sent by the functional module receiving the write command packet to the remote I2C slave device is the remote I2C address contained in the write command packet.

Further, the functional module receiving the write command packet includes a remote I2C address register and a remote I2C address selection module; the I2C address contained in the remote I2C address byte sent by the functional module receiving the write command packet to the remote I2C slave device is derived from the remote I2C address stored in the remote I2C address register or the remote I2C address contained in the write command packet according to the instruction of the remote I2C address selection module.

Another objective of the present invention is to provide a multi-target data writing method based on an interface system, where the interface system includes an I2C master controller, an I2C interface module and a plurality of functional modules, the I2C master controller is connected to the I2C interface module, and the I2C interface module is connected to the plurality of functional modules. The method is characterized in that:

The I2C master controller initiates an I2C write operation to send a write command packet to the I2C interface module, and then initiates a subsequent I2C read operation to read status information;
after receiving an address byte of the subsequent I2C read operation, the I2C interface module pulls down the level of the I2C clock line and sends the received write command packet to one or more functional modules;
the functional modules receiving the write command packet execute one or more write commands contained in the write command packet and return a write status packet to the I2C interface module, including:
when the execution result of each write command contained in the write command packet is successful, the functional module returns a write status packet with successful status information to the I2C interface module;
when the execution result of at least one write command contained in the write command packet is failed, the functional module returns a write status packet with failed status information to the I2C interface module;
after receiving the write status packet from each functional module to which it sends the write command packet, the I2C interface module stops pulling down the level of the I2C clock line and returns the status information of the write status packet to the I2C master controller.

The multi-target data writing method provided by the present invention has a high data transmission speed, enables a single I2C interface or a single SPI interface to perform parallel data transmission to multiple target devices, and the selection of multiple target devices can be configured.

### BRIEF DESCRIPTION OF DRAWINGS

To explain the specific embodiments of the present invention or the technical solutions in the prior art more clearly, the drawings required for the specific embodiments or the description of the prior art will be briefly introduced below. Obviously, the drawings in the following description are some embodiments of the present invention, and those skilled in the art can obtain other drawings according to these drawings without creative work.

FIG. 1 schematically shows a structural block diagram of an interface system of the present invention.

FIG. 2 shows a schematic diagram of a data structure of a write command packet of the present invention.

FIG. 3 shows a structural block diagram of the interface system of the present invention where the master controller is an I2C master controller and the interface module is an I2C interface module.

FIG. 4 shows a timing diagram of an I2C write operation of the present invention.

FIG. 5 shows a timing diagram of an I2C read operation of the present invention.

FIG. 6 shows a timing diagram of a continuous I2C read-write operation of the present invention.

FIG. 7 shows a timing diagram of initiating an I2C write operation to send a write command packet (or a read command packet) of the present invention.

FIG. 8 shows a timing diagram of initiating an I2C write operation to send a write command packet with successful status information of the write status packet and a timing diagram with failed status information of the write status packet in an embodiment of the present invention.

FIG. 9 shows a timing diagram of initiating an I2C write operation to send a write command packet with a subsequent I2C operation being an I2C read operation in an embodiment of the present invention.

FIG. 10 shows a timing diagram of initiating an I2C write operation to send a write command packet with a subsequent I2C operation being an I2C read operation in another embodiment of the present invention.

FIG. 11 shows a timing diagram of initiating an I2C write operation to send a write command packet with successful status information of the write status packet in another embodiment of the present invention.

FIG. 12 shows a timing diagram of initiating an I2C write operation to send a write command packet with failed status information of the write status packet in another embodiment of the present invention.

FIG. 13 shows a structural block diagram of the interface system of the present invention where the master controller is an SPI master controller and the interface module is an SPI interface module.

FIG. 14 shows a schematic diagram of a data structure of a write command packet when the master controller is an SPI master controller and the interface module is an SPI interface module of the present invention.

FIG. 15 shows a timing diagram of a first embodiment of SPI data writing of the present invention.

FIG. 16 shows a timing diagram of a second embodiment of SPI data writing of the present invention.

FIG. 17 shows a timing diagram of a third embodiment of SPI data writing of the present invention.

FIG. 18 shows a timing diagram of a fourth embodiment of SPI data writing of the present invention.

FIG. 19 shows a timing diagram of a fifth embodiment of SPI data writing of the present invention.

FIG. 20 schematically shows a structural block diagram of the functional module of the interface system of the present invention connected to a remote I2C slave device.

FIG. 21 shows a schematic diagram of the functional module returning a write status packet with successful status information to the interface module of the present invention.

FIG. 22 shows a schematic diagram of the functional module returning a write status packet with failed status information to the interface module in an embodiment of the present invention.

FIG. 23 shows a schematic diagram of the functional module returning a write status packet with failed status information to the interface module in another embodiment of the present invention.

The meanings of the text identifiers in the above drawings are as follows:
100: Master controller; 100a: I2C master controller; 100b: SPI master controller;
200: Interface module; 200a: I2C interface module; 200b: SPI interface module;
SDA: I2C data line; SCL: I2C clock line;
S: Representing an I2C START signal, the corresponding I2C bus state is that SDA has a transition from high level to low level when SCL is high;
P: Representing an I2C STOP signal, the corresponding I2C bus state is that SDA has a transition from low level to high level when SCL is high;
Sr: The corresponding I2C bus state is the same as S;
Sr/P: The corresponding I2C bus state is Sr or P;
ADDR: I2C address;
R/W: Representing a read/write operation indicator bit, where the bit is R for an I2C read operation and W for an I2C write operation;
R: Representing a read operation indicator bit, the corresponding I2C bus state is that SDA is high during the period when SCL is high;
W: Representing a write operation indicator bit, the corresponding I2C bus state is that SDA is low during the period when SCL is high;
BYTE: Write operation data or read operation data, usually a multi-byte sequence, where the content in parentheses after the BYTE indicates the serial number of the byte in the sequence; a write command packet or a read command packet is sent through write operation data, and read data or status information is read through read operation data; bytes with smaller serial numbers are sent first;
A: Representing an I2C ACK, the corresponding I2C bus state is that SDA is always low during the period when SCL is high;
N: Representing an I2C NAK, the corresponding I2C bus state is that SDA is always high during the period when SCL is high;
STATUS: A sequence composed of bytes containing status information and I2C ACK/I2C NAK between the bytes;
A/N: The corresponding I2C bus state is that SDA is always high or always low during the period when SCL is high;
HOLD: SCL is at a continuous low level;
IDLE: The corresponding I2C bus state includes the following two possibilities:
(1) Both SCL and SDA are at high level;
(2) SCL and SDA may have other level states, but no valid I2C operation appears in the combination of these level states, and both SCL and SDA are at high level when IDLE is about to end;
SPI_CK: SPI_CK signal line; SPI_MOSI: SPI_MOSI signal line; SPI_MISO: SPI_MISO signal line; SPI_CSN: SPI_CSN signal line.

### DETAILED DESCRIPTION OF EMBODIMENTS

To make the above and other features and advantages of the present invention clearer, the present invention will be further described below with reference to the accompanying drawings. It should be understood that the specific embodiments provided herein are for the purpose of explaining to those skilled in the art, and are merely exemplary and not restrictive.

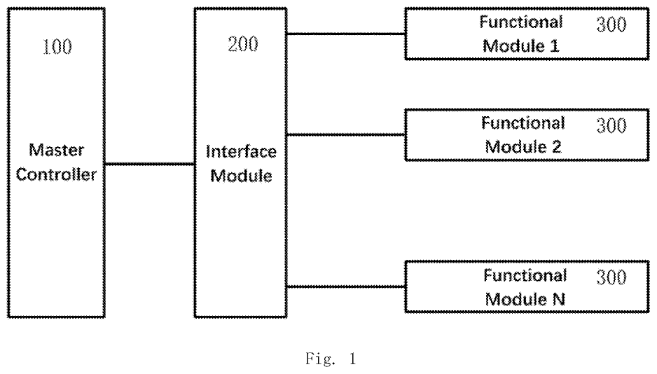

As shown in FIG. 1, according to an embodiment of the present invention, an interface system is provided, which is characterized in that the interface system includes a master controller 100, an interface module 200 and a plurality of functional modules 300. The master controller 100 is connected to the interface module 200, the interface module 200 is connected to the plurality of functional modules 300, and the serial numbers of the functional modules 300 are denoted by 1 to N.

According to an embodiment of the present invention, a multi-target data writing method is provided, including:

The master controller 100 sends a write command packet to the interface module 200, and after receiving the write command packet, the interface module 200 sends the write command packet to one or more functional modules 300.

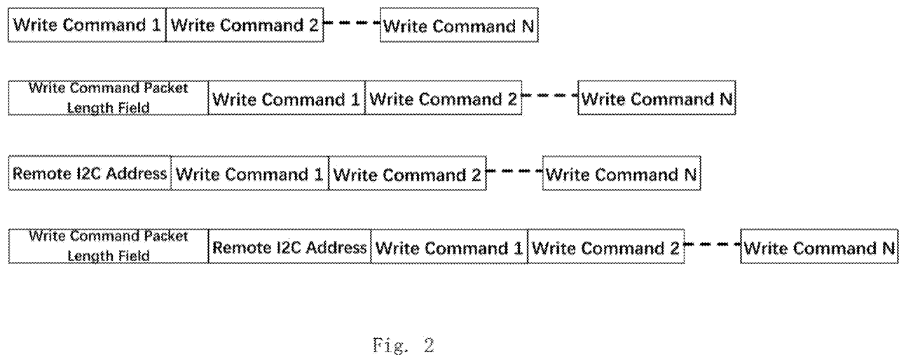

As shown in FIG. 2, the write command packet of the present invention contains one or more write commands, and an exemplary write command packet contains write command 1, write command 2, . . . , write command N.

The functional modules 300 receiving the write command packet execute one or more write commands contained in the write command packet and return a write status packet to the interface module 200, including:
when the execution result of each write command contained in the write command packet is successful, the functional module 300 returns a write status packet with successful status information to the interface module 200;
when the execution result of at least one write command contained in the write command packet is failed, the functional module 300 returns a write status packet with failed status information to the interface module 200.

The interface module 200 receives the write status packet from each functional module 300 to which it sends the write command packet, and returns the status information of the write status packet to the master controller 100.

In an embodiment, the functional module 300 receiving the write command packet receives the write command packet and executes one or more write commands contained in the write command packet; when the execution result of a write command is failed, the functional module 300 stops executing subsequent write commands and returns a write status packet with failed status information to the interface module 200.

After receiving the write command packet, the interface module 200 sends the write command packet to one or more functional modules 300, and the one or more target functional modules 300 to which the interface module 200 sends the write command packet can be configured. In an embodiment, the master controller 100 can send target functional module configuration information before sending the write command packet, and the interface module 200 sends the write command packet to one or more target functional modules 300 indicated by the target functional module configuration information according to the target functional module configuration information. In another embodiment, the master controller 100 can also send the target functional module configuration information to the interface module 200 by including it in the write command packet, and after receiving the write command packet, the interface module 200 sends the write command packet to one or more target functional modules 300 indicated by the target functional module configuration information according to the target functional module configuration information.

The configuration of the target functional modules can be dynamic, that is, the target functional module configuration information can be selectively modified before sending the write command packet; when the target functional module configuration information is included in the write command packet, the target functional module configuration information in different write command packets can be different. The configuration of the target functional modules can also be static, that is, the target functional module configuration information can be preset and not modified during the operation of the system. The present invention does not limit the configureuration means or method of the target functional modules, and any configuration means or method is within the protection scope of the present invention; the present invention also does not limit whether the configuration of the target functional modules is dynamic or static.

In the present invention, the number of target functional modules indicated by the target functional module configuration information can be equal to or less than the number of functional modules 300 connected to the interface module 200, that is, the target functional modules indicated by the target functional module configuration information can be all the functional modules 300 connected to the interface module 200 or a subset of all the functional modules 300 connected to the interface module 200.

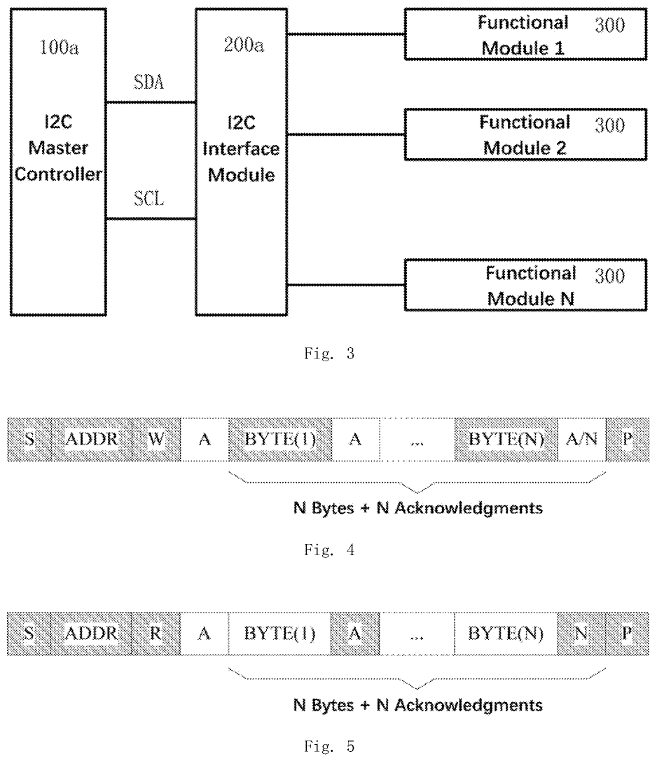

As shown in FIG. 3, in an embodiment, the master controller 100 is an I2C master controller 100a, and the interface module 200 is an I2C interface module 200a.

The I2C master controller 100a is connected to the I2C interface module 200a via an I2C clock line (SCL) and an I2C data line (SDA), initiates an I2C write operation to send the write command packet to the I2C interface module 200a, and after receiving the write command packet, the I2C interface module 200a pulls down the level of the I2C clock line (SCL) and sends the write command packet to one or more functional modules 300.

The functional modules 300 receiving the write command packet execute one or more write commands contained in the write command packet and return the write status packet to the I2C interface module 200a; the I2C interface module 200a receives the write status packet from each functional module 300 to which it sends the write command packet and returns the status information of the write status packet to the I2C master controller 100a, including:
when the I2C interface module 200a receives the write status packet from each functional module 300 to which it sends the write command packet and the status information of each write status packet is successful, the I2C interface module 200a stops pulling down the level of the I2C clock line (SCL) and returns an I2C ACK to the I2C master controller 100a;
when the I2C interface module 200a receives the write status packet from each functional module 300 to which it sends the write command packet and the status information of at least one write status packet is failed, the I2C interface module 200a stops pulling down the level of the I2C clock line (SCL) and returns an I2C NAK to the I2C master controller 100a.

As shown in FIG. 4, an I2C write operation includes a write address byte and one or more write operation data bytes (BYTE (1), . . . , BYTE (N), shaded). The write address byte is the first sent byte, and includes an I2C address (ADDR) and a write operation indicator bit (W). According to the standard I2C specification, the write operation indicator bit (W) is low.

In this embodiment, both the write address byte and the write operation data byte are 8 bits, where the write address byte includes a 7-bit I2C address (ADDR) and a 1-bit write operation indicator bit (W). The present invention does not limit the number of bits of the write address byte and the write operation data byte; in other embodiments, the write address byte and the write operation data byte can have other numbers of bits.

When the I2C master controller 100a initiates an I2C write operation, it first drives the I2C clock line (SCL) and the I2C data line (SDA) according to the standard I2C specification to generate an I2C START signal(S), then sends the write address byte, and the I2C interface module 200a drives the I2C data line (SDA) to generate an acknowledgment bit after receiving the write address byte. According to the standard I2C specification, the acknowledgment bit can be an I2C ACK (the level of the I2C data line is low) or an I2C NAK (the level of the I2C data line is high).

When the acknowledgment bit of the write address byte is an I2C ACK, the I2C master controller 100a can send one or more write operation data bytes, and the I2C interface module 200a drives the I2C data line (SDA) to generate an acknowledgment bit after receiving each write operation data byte; the acknowledgment bit of the write operation data byte can be an I2C ACK (the level of the I2C data line is low) or an I2C NAK (the level of the I2C data line is high).

According to the standard I2C specification, when sending the write address byte and one or more write operation data bytes, the I2C master controller 100a sends the number of bits contained in the write address byte and the write operation data byte by driving the I2C data line (SDA), and generates a clock pulse on the I2C clock line (SCL) for each bit contained in the write address byte and the write operation data byte.

According to the standard I2C specification, the I2C master controller 100a also generates a clock pulse on the I2C clock line (SCL) corresponding to the acknowledgment bit of the write address byte and the acknowledgment bit of the write operation data byte. The I2C master controller 100a ends the current write operation by sending an I2C STOP signal (P) or an I2C START signal(S) defined by the standard I2C specification.

As shown in FIG. 5, an I2C read operation includes a read address byte and one or more read operation data bytes (BYTE (1), . . . , BYTE (N), unshaded). The read address byte is the first byte sent by the I2C master controller 100a, and the one or more read operation data bytes are sent by the I2C interface module 200a. The read address byte includes an I2C address (ADDR) and a read operation indicator bit (R). According to the standard I2C specification, the read operation indicator bit (R) is high.

In this embodiment, both the read address byte and the read operation data byte are 8 bits, where the read address byte includes a 7-bit I2C address (ADDR) and a 1-bit read operation indicator bit (R). The present invention does not limit the number of bits of the read address byte and the read operation data byte; in other embodiments, the read address byte and the read operation data byte can have other numbers of bits.

When the I2C master controller 100a initiates an I2C read operation, it first drives the I2C clock line and the I2C data line according to the standard I2C specification to generate an I2C START signal(S), then sends the read address byte, and the I2C interface module 200a drives the I2C data line to generate an acknowledgment bit after receiving the read address byte; according to the standard I2C specification, the acknowledgment bit can be an I2C ACK (the level of the I2C data line is low) or an I2C NAK (the level of the I2C data line is high).

When the acknowledgment bit of the read address byte is an I2C ACK, the I2C interface module 200a can return one or more read operation data bytes by driving the I2C data line, and the I2C master controller 100a drives the I2C data line to generate an acknowledgment bit after receiving each read operation data byte; the acknowledgment bit of the read operation data byte can be an I2C ACK (the level of the I2C data line is low) or an I2C NAK (the level of the I2C data line is high).

According to the standard I2C specification, when the I2C master controller 100a sends the read address byte and the I2C interface module 200a returns one or more read operation data bytes, the I2C master controller 100a sends the number of bits contained in the read address byte by driving the I2C data line, the I2C interface module 200a returns the bits contained in the read operation data bytes by driving the I2C data line, and the I2C master controller 100a generates a clock pulse on the I2C clock line for each bit contained in the read address byte and the read operation data bytes.

According to the standard I2C specification, the I2C master controller 100a also generates a clock pulse on the I2C clock line corresponding to the acknowledgment bit of the read address byte and the acknowledgment bit of the read operation data byte. The I2C master controller 100a ends the current read operation by sending an I2C STOP signal (P) or an I2C START signal(S) defined by the standard I2C specification.

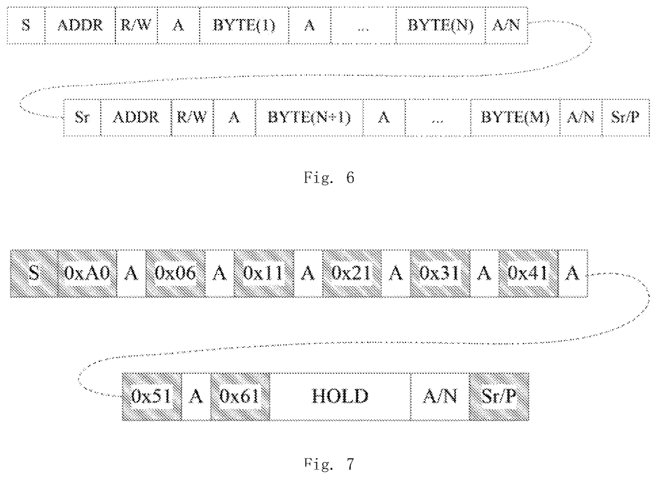

Each I2C write operation or I2C read operation cycle starts with an I2C START signal(S), but has two ending modes: the first is ending with an I2C STOP signal (P), the timing diagrams of which are shown in FIG. 4 and FIG. 5 respectively;
the second is generating a new I2C START signal(S) to enter the next I2C write operation or I2C read operation, the timing diagram of which is shown in FIG. 6. In FIG. 6, a dashed line connection appears between the acknowledgment bit (A/N) and the I2C START signal (Sr) (such connections in other drawings) because the timing diagram is too long to be described in the same line, so it is split into multiple lines, indicating that there is a connection relationship between the two timing diagrams.

The use of any of the above ending modes will not affect the multi-target data writing method of the present invention. For the convenience of description, the ending of an I2C operation (I2C write operation or I2C read operation) is described in this embodiment in a manner with an I2C STOP signal (P).

The write command packet of the present invention is sent through write operation data bytes (BYTE (1), . . . , BYTE (N), shaded). As shown in FIG. 2, four embodiments of the write command packet are provided:

The write command packet may only contain write command 1, write command 2, . . . , write command N;
the write command packet may also contain a write command packet length field and write command 1, write command 2, . . . , write command N;
the write command packet may also contain a remote I2C address and write command 1, write command 2, . . . , write command N;
the write command packet may also contain a write command packet length field, a remote I2C address and write command 1, write command 2, . . . , write command N.

The write command packet may also contain target functional module configuration information (not shown in FIG. 2) for indicating one or more target functional modules 300.

It should be noted that the present invention does not limit the format of the write command packet, that is, the format of the write command packet in the present invention is not limited to the four embodiments of the write command packet shown in FIG. 2, and the I2C master controller 100a and the I2C interface module 200a can agree on other formats of the write command packet.

The write command packet of the present invention is used to distinguish from a read command packet; the write command packet is used to realize data writing, and the read command packet is used to realize data reading. The present invention does not limit the method for reading data through the read command packet.

For example, when the I2C master controller 100a initiates a write command packet, it initiates an I2C write operation to send the write address byte and one or more write operation data bytes (BYTE (1), . . . , BYTE (N), shaded) containing the write command packet to the I2C interface module 200a.

The I2C interface module 200a has a logic circuit of an I2C interface, and receives and responds to data from the I2C master controller 100a. The I2C interface module 200a and the I2C master controller 100a are interconnected via an I2C bus (I2C clock line and I2C data line). One I2C master controller 100a can be connected to one or more I2C interface modules 200a, and each I2C interface module 200a has a unique I2C address (ADDR) on its located I2C bus (I2C clock line and I2C data line). According to the standard I2C specification, each I2C write operation or I2C read operation except I2C write broadcasting is only for one I2C address (ADDR), and the I2C interface modules 200a using other I2C addresses do not participate in the I2C write operation or I2C read operation.

As shown in FIG. 7, in a specific embodiment, the I2C interface module 200a has a 7-bit I2C address 0x50 (corresponding to a write address byte 0xA0 or a binary value 1010000), and the I2C master controller 100 a initiates an I2C write operation to sequentially write 7 bytes of write operation data including 0x06, 0x11, 0x21, 0x31, 0x41, 0x51 and 0x61 to the I2C interface module 200a, where the 7 bytes of write operation data contain the write command packet. The byte 0xA0 corresponds to the write address byte, the high 7 bits of which correspond to the I2C address (ADDR) of the I2C interface module 200a, and the low 1 bit is the write operation indicator bit (W); the value of the write operation indicator bit (W) is 0, indicating a current write operation, and the value of the byte is a binary number 10100000, i.e., a hexadecimal number 0xA0.

In this example, the format of the write command packet can be the four embodiments of the write command packet shown in FIG. 2, or other formats agreed between the I2C master controller 100a and the I2C interface module 200a.

In the present invention, the I2C interface module 200a receiving the write command packet means that the write operation data received by the I2C interface module 200a contains a complete write command packet. In the embodiment shown in FIG. 7, the 7 bytes of write operation data including 0x06, 0x11, 0x21, 0x31, 0x41, 0x51 and 0x61 contain a complete write command packet; therefore, the I2C interface module 200a receives the write command packet when it receives the last bit of the byte 0x61.

As shown in FIG. 2, the write command packet may contain a write command packet length field, and the I2C interface module 200a can determine whether the received write operation data contains a complete write command packet based on the write command packet length field (or partially based on the write command packet length field) according to the agreement with the I2C master controller 100a. As shown in FIG. 2, the write command packet may also not contain a write command packet length field; in this case, the I2C interface module 200a can determine whether the received write operation data contains a complete write command packet according to the agreement with the I2C master controller 100a (the agreement is not based on the write command packet length field).

In the embodiment shown in FIG. 7, the I2C interface module 200a receives the write command packet when it receives the last bit of the byte 0x61, then pulls down the level of the I2C clock line, the I2C bus is in a HOLD state (continuous low level state), and the I2C interface module 200a sends the write command packet to one or more functional modules 300. The functional modules 300 receiving the write command packet receive the write command packet and execute one or more write commands contained in the write command packet, i.e., write command 1, write command 2, . . . , write command N, and then return a write status packet to the I2C interface module 200a, including:
when the execution result of each write command contained in the write command packet is successful, the functional module 300 returns a write status packet with successful status information to the I2C interface module 200a;
when the execution result of at least one write command contained in the write command packet is failed, the functional module 300 returns a write status packet with failed status information to the I2C interface module 200a.

In the present invention, when the I2C interface module 200a sends the write command packet to the functional module 300, it can modify, add or delete the content in the write command packet, which is not limited or specified by the present invention.

According to an embodiment of the present invention, when the I2C interface module 200a receives the write status packet from each functional module 300 to which it sends the write command packet and the status information of each write status packet is successful, the I2C interface module 200a stops pulling down the level of the I2C clock line and returns an I2C ACK to the I2C master controller 100a;
when the I2C interface module 200a receives the write status packet from each functional module 300 to which it sends the write command packet and the status information of at least one write status packet is failed, the I2C interface module 200a stops pulling down the level of the I2C clock line and returns an I2C NAK to the I2C master controller 100a.

The subsequent I2C operation referred to in the present invention is relative to the I2C operation before it, and the I2C operation can be an I2C write operation or an I2C read operation.

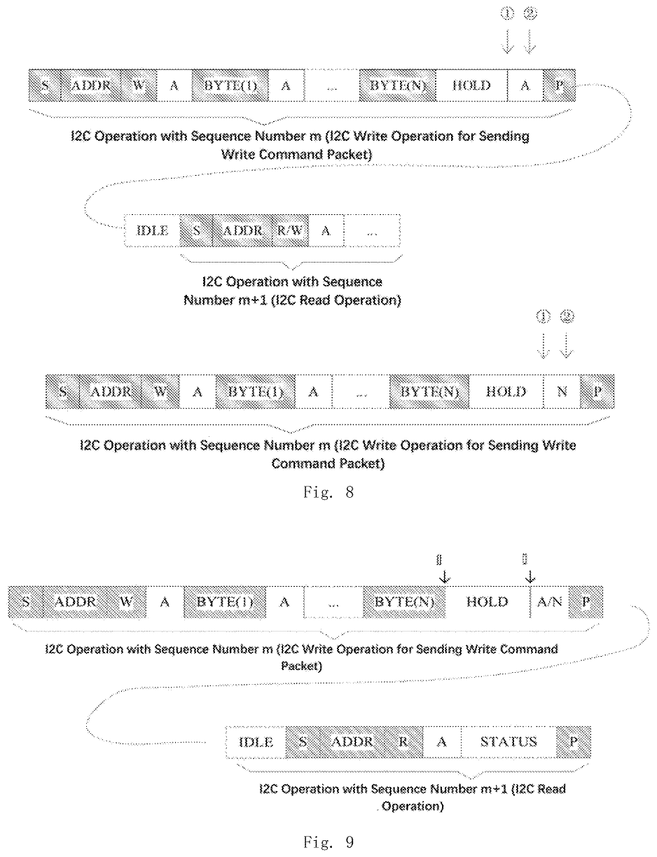

As shown in FIG. 8, examples are respectively given to describe the case where the I2C interface module 200a receives the write status packet from each functional module 300 to which it sends the write command packet and the status information of each write status packet is successful, and the case where the I2C interface module 200a receives the write status packet from each functional module 300 to which it sends the write command packet and the status information of at least one write status packet is failed.

The I2C master controller 100a initiates an I2C operation (I2C write operation) with a serial number m (m is a natural number), and the I2C operation with a serial number m+1 initiated by the I2C master controller 100a is a subsequent I2C operation (relative to the I2C operation with the serial number m).

In an embodiment shown in FIG. 8, the I2C master controller 100a sends a write command packet through the I2C write operation with the serial number m, and the I2C interface module 200a pulls down the level of the I2C clock line after receiving the write command packet (after receiving BYTE(N)).

At time \textcircled{1}, the I2C interface module 200a receives the write status packet from each functional module 300 to which it sends the write command packet and the status information of each write status packet is successful, the I2C interface module 200a stops pulling down the level of the I2C clock line and terminates the HOLD state (terminates the continuous low level state).

At time \textcircled{2}, the I2C interface module 200a returns an I2C ACK to the I2C master controller 100a, the I2C master controller 100a terminates the I2C operation (I2C write operation) with the serial number m and initiates the I2C operation (subsequent I2C operation) with the serial number m+1, where the subsequent I2C operation is an I2C write operation or an I2C read operation.

After returning the I2C ACK in the I2C operation with the serial number m, the I2C interface module 200a continues to receive the subsequent I2C operation initiated by the I2C master controller 100a (referring to returning an I2C ACK after receiving a read address byte or a write address byte in the I2C operation with the serial number m+1 and continuing the I2C operation with the serial number m+1). If the subsequent I2C operation is an I2C write operation, the I2C interface module 200a returns an I2C ACK after receiving the write address byte and continues to receive write operation bytes; if the subsequent I2C operation is an I2C read operation, the I2C interface module 200a returns an I2C ACK after receiving the read address byte and continues to return the status information (STATUS) of the write status packet (the part of the subsequent I2C operation after the read address byte or the write address byte is not shown in FIG. 8 in this example).

In another embodiment shown in FIG. 8, the I2C master controller 100a sends a write command packet through the I2C write operation with the serial number m, and the I2C interface module 200a pulls down the level of the I2C clock line after receiving the write command packet (after receiving BYTE(N)).

At time \textcircled{1}, the I2C interface module 200a receives the write status packet from each functional module 300 to which it sends the write command packet and the status information of at least one write status packet is failed, the I2C interface module 200a stops pulling down the level of the I2C clock line and terminates the HOLD state (terminates the continuous low level state).

At time \textcircled{2}, the I2C interface module 200a returns an I2C NAK to the I2C master controller 100a, and the I2C master controller 100a terminates the I2C operation (I2C write operation) with the serial number m.

After returning the I2C NAK in the I2C operation with the serial number m, if the I2C master controller 100a initiates a subsequent I2C operation and the subsequent I2C operation is an I2C write operation, the I2C interface module 200a returns an I2C NAK to the I2C master controller 100a after receiving the write address byte, thus the subsequent I2C operation (I2C write operation) is terminated. After returning the I2C NAK in the I2C operation with the serial number m, if the I2C master controller 100a initiates a subsequent I2C operation and the subsequent I2C operation is an I2C read operation, the I2C interface module 200a returns an I2C ACK to the I2C master controller 100a after receiving the read address byte and continues to return the status information (STATUS) of the write status packet; after completing the subsequent I2C operation (I2C read operation), the I2C interface module 200a can continue to receive further subsequent I2C operations initiated by the I2C master controller 100a (the part of the subsequent I2C operation is not shown in FIG. 8 in this example).

In the present invention, the status information (STATUS) may be the success or failure information contained in the write status packet, and may also contain other information contained in the write status packet. In an embodiment, the status information (STATUS) may respectively contain the success or failure information contained in each write status packet received by the I2C interface module 200a. After receiving the status information, the I2C master controller 100a can know the execution status of the write command packet by each functional module 300 receiving the write command packet according to the status information, and then perform subsequent processing according to the execution status. As shown in the embodiment in FIG. 8, after the I2C interface module 200a receives the write status packet from each functional module 300 to which it sends the write command packet, it stops pulling down the level of the I2C clock line and returns an I2C ACK (when the status information of each write status packet is successful) or an I2C NAK (when the status information of at least one write status packet is failed) to the I2C master controller 100a. If the I2C master controller 100a initiates a subsequent I2C operation and the subsequent I2C operation is an I2C read operation, the I2C interface module 200a returns an I2C ACK to the I2C master controller 100a after receiving the read address byte and continues to return the status information (STATUS) of the write status packet.

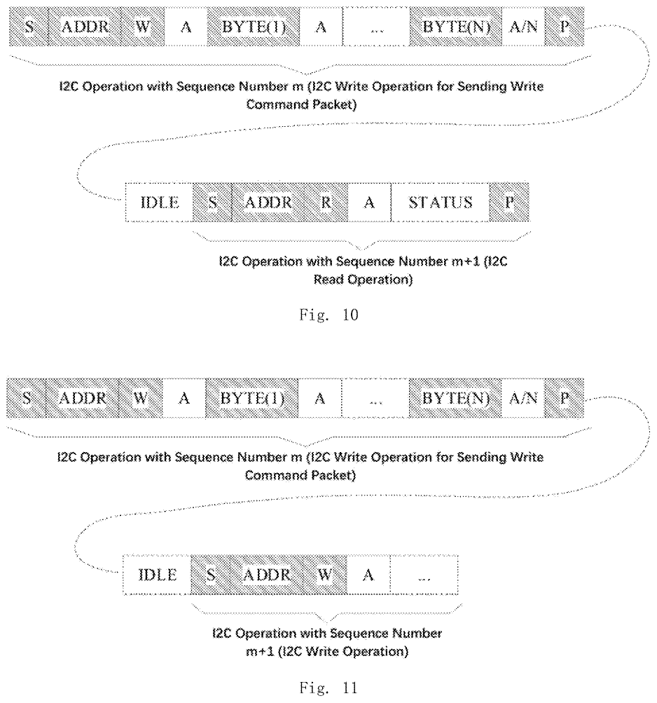

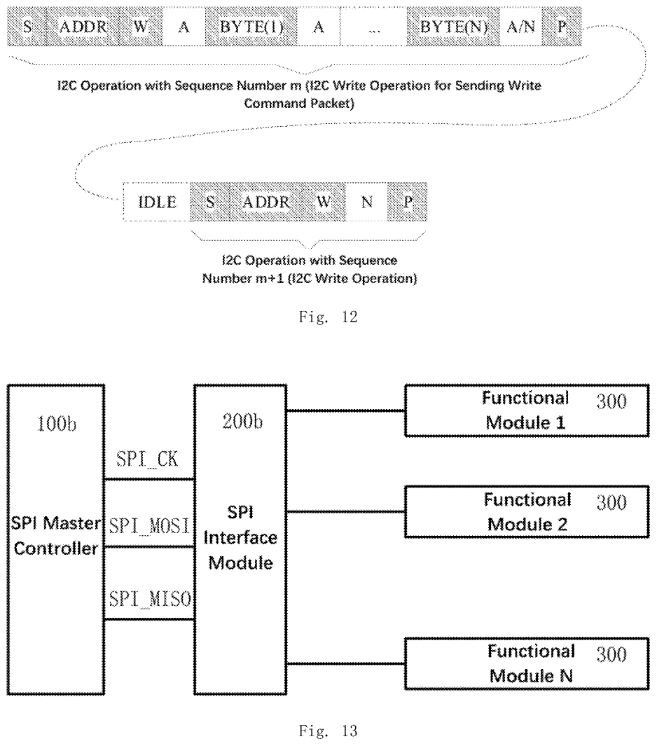

In the embodiment shown in FIG. 9, the I2C master controller 100a sends a write command packet through the I2C write operation with the serial number m, the I2C interface module 200a pulls down the level of the I2C clock line after receiving the write command packet (after receiving BYTE(N)), and stops pulling down the level of the I2C clock line and returns an I2C ACK or an I2C NAK to the I2C master controller 100a after receiving the write status packet from each functional module 300 to which it sends the write command packet. In this example, the specific meaning of the I2C ACK or the I2C NAK can be agreed by the I2C master controller 100a and the I2C interface module 200a by themselves. After the I2C interface module 200a stops pulling down the level of the I2C clock line and returns an I2C ACK or an I2C NAK to the I2C master controller 100a, if the I2C master controller 100a initiates a subsequent I2C operation and the subsequent I2C operation is an I2C write operation, the I2C interface module 200a returns an I2C NAK to the I2C master controller 100a after receiving the write address byte, thus the subsequent I2C operation (I2C write operation) is terminated; if the I2C master controller 100a initiates a subsequent I2C operation and the subsequent I2C operation is an I2C read operation, the I2C interface module 200a returns an I2C ACK to the I2C master controller 100a after receiving the read address byte and continues to return the status information (STATUS) of the write status packet. After completing the subsequent I2C operation (I2C read operation), the I2C interface module 200a can continue to receive further subsequent I2C operations initiated by the I2C master controller 100a (the part where the subsequent I2C operation is an I2C write operation is not shown in FIG. 9 in this example).

According to an embodiment of the present invention, the I2C master controller 100a is connected to the I2C interface module 200a via an I2C clock line and an I2C data line, initiates an I2C write operation to send the write command packet to the I2C interface module 200a, and after receiving the write command packet, the I2C interface module 200a sends the write command packet to one or more functional modules 300.

The functional modules 300 receiving the write command packet execute one or more write commands contained in the write command packet, i.e., write command 1, write command 2, . . . , write command N, and then return a write status packet to the I2C interface module 200a, including:
when the execution result of each write command contained in the write command packet is successful, the functional module 300 returns a write status packet with successful status information to the I2C interface module 200a;
when the execution result of at least one write command contained in the write command packet is failed, the functional module 300 returns a write status packet with failed status information to the I2C interface module 200a.

In the present invention, when the I2C interface module 200a sends the write command packet to the functional module 300, it can modify, add or delete the content in the write command packet, which is not limited or specified by the present invention.

The functional modules 300 receiving the write command packet return the write status packet to the I2C interface module 200a, and the I2C interface module 200a returns the status information of the write status packet to the I2C master controller 100a, including:

After the I2C interface module 200a receives the write command packet:
if a subsequent I2C operation initiated by the I2C master controller 100a is an I2C read operation, and the I2C interface module 200a receives the write status packet from each functional module 300 to which it sends the write command packet, the I2C interface module 200a returns the status information of the write status packet to the I2C master controller 100a;
if the subsequent I2C operation initiated by the I2C master controller 100a is an I2C write operation, and the I2C interface module 200a receives the write status packet from each functional module 300 to which it sends the write command packet and the status information of each write status packet is successful, the I2C interface module 200a receives the subsequent I2C write operation initiated by the I2C master controller 100a; if the subsequent I2C operation initiated by the I2C master controller 100a is an I2C write operation, and the I2C interface module 200a receives the write status packet from each functional module 300 to which it sends the write command packet and the status information of at least one write status packet is failed, the I2C interface module 200a returns an I2C NAK to the I2C master controller 100a.

As shown in FIG. 10, the I2C operation with the serial number m initiated by the I2C master controller 100a is an I2C write operation for sending a write command packet to the I2C interface module 200a. For the first N−1 write operation data bytes (BYTE(1), . . . , BYTE(N−1)), the I2C interface module 200a returns an I2C ACK to the I2C master controller 100a after each write operation data byte is sent.

After receiving the Nth write operation data byte (BYTE(N)) (i.e., after the I2C interface module 200a receives a complete write command packet), the I2C interface module 200a may return an I2C ACK or an I2C NAK to the I2C master controller 100a, which is selected specifically according to the agreement between the I2C master controller 100a and the I2C interface module 200a. The I2C master controller 100a and the I2C interface module 200a may agree that both the I2C ACK and the I2C NAK after the Nth write operation data byte (BYTE(N)) indicate the successful reception of the Nth write operation data byte (i.e., the complete write command packet), or may agree that the I2C NAK indicates the unsuccessful reception of the Nth write operation data byte (BYTE(N)) (i.e., the complete write command packet is not successfully received). In the following description of the present invention, both the I2C ACK and the I2C NAK returned by the I2C interface module 200a to the I2C master controller 100a after the Nth write operation data byte (BYTE(N)) indicate the successful reception of the Nth write operation data byte (i.e., the complete write command packet).

After the I2C master controller 100a completes the sending of the Nth write operation data byte (BYTE(N)), regardless of whether the I2C interface module 200a returns an I2C ACK or an I2C NAK to the I2C master controller 100a, the I2C master controller 100a terminates the I2C operation (I2C write operation) with the serial number m and can select to initiate the I2C operation (subsequent I2C operation) with the serial number m+1.

When the I2C operation (subsequent I2C operation) with the serial number m+1 is an I2C read operation, if the I2C interface module 200a receives the write status packet (the write status packet corresponding to the I2C operation with the serial number m) from each functional module 300 to which it sends the write command packet, the I2C interface module 200a returns an I2C ACK to the I2C master controller 100a and returns the status information (STATUS) of the write status packet after the I2C master controller 100a sends the read address byte.

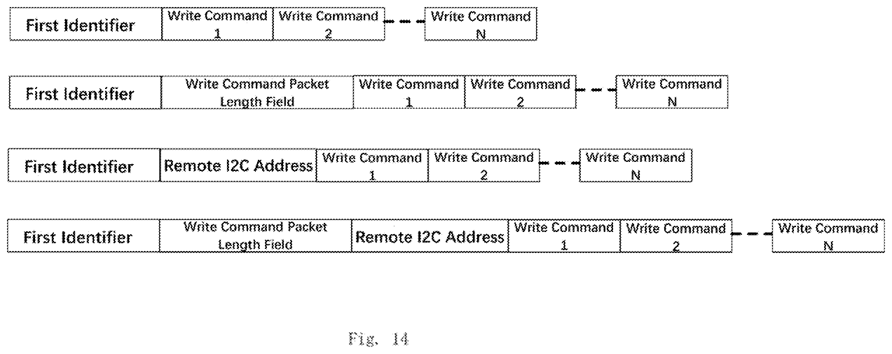

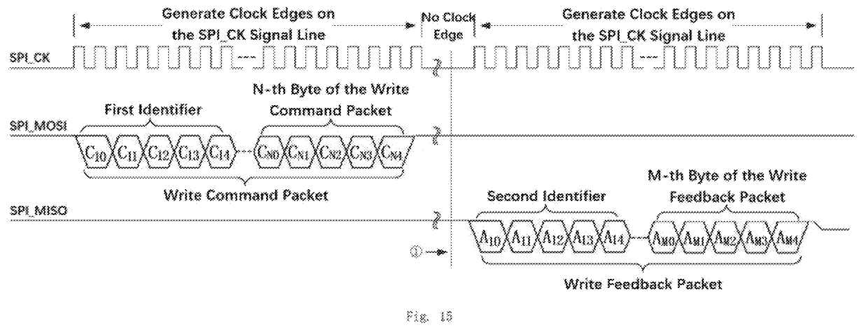

As shown in FIG. 11 and FIG. 12, the I2C operation with the serial number m initiated by the I2C master controller 100a is an I2C write operation for sending a write command packet to the I2C interface module 200a. For the first N−1 write operation data bytes (BYTE(1), . . . , BYTE(N−1)), the I2C interface module 200a returns an I2C ACK to the I2C master controller 100a after each write operation data byte is sent.

After receiving the Nth write operation data byte (BYTE(N)) (i.e., after the I2C interface module 200a receives a complete write command packet), the I2C interface module 200a may return an I2C ACK or an I2C NAK to the I2C master controller 100a.

After the I2C master controller 100a completes the sending of the Nth write operation data byte (BYTE(N)), regardless of whether the I2C interface module 200a returns an I2C ACK or an I2C NAK to the I2C master controller 100a, the I2C master controller 100a terminates the I2C operation (I2C write operation) with the serial number m and can select to initiate the I2C operation (subsequent I2C operation) with the serial number m+1.

When the I2C operation (subsequent I2C operation) with the serial number m+1 is an I2C write operation, if the I2C interface module 200a receives the write status packet (the write status packet corresponding to the I2C operation with the serial number m) from each functional module 300 to which it sends the write command packet and the status information of each write status packet is successful, the I2C interface module 200a returns an I2C ACK to the I2C master controller 100a after the I2C master controller 100a sends the write address byte, and the I2C interface module 200a receives the write operation data bytes sent by the I2C operation (subsequent I2C operation/I2C write operation) with the serial number m+1 initiated by the I2C master controller 100a, as shown in FIG. 11.

If the I2C interface module 200a receives the write status packet (the write status packet corresponding to the I2C operation with the serial number m) from each functional module 300 to which it sends the write command packet and the status information of at least one write status packet is failed, the I2C interface module 200a returns an I2C NAK to the I2C master controller 100a after the I2C master controller 100a sends the write address byte, and the master controller 100a terminates the initiation of the I2C operation (subsequent I2C operation/I2C write operation) with the serial number m+1, as shown in FIG. 12.

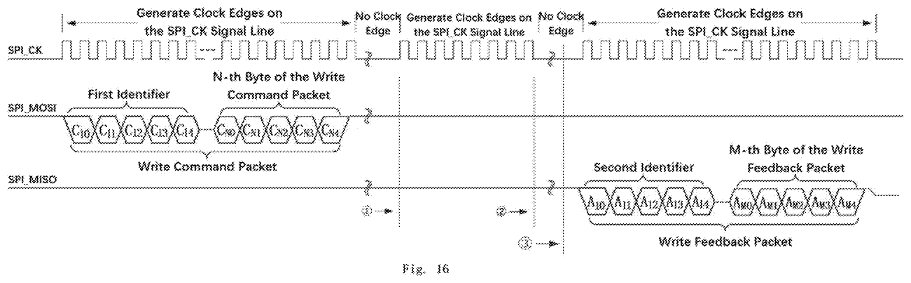

As shown in FIG. 13, in an embodiment, the master controller 100 is an SPI master controller 100b, the interface module 200 is an SPI interface module 200b, and the SPI master controller 100b is connected to the SPI interface module 200b via an SPI_CK signal line, an SPI_MOSI signal line and an SPI_MISO signal line.

The SPI master controller 100b generates clock edges on the SPI_CK signal line and sends the write command packet to the SPI interface module 200b via the SPI_MOSI signal line, where the write command packet starts with a first identifier; after receiving the write command packet from the SPI_MOSI, the SPI interface module 200b sends the write command packet to one or more functional modules 300.

The functional modules 300 receiving the write command packet execute one or more write commands contained in the write command packet, i.e., write command 1, write command 2, . . . , write command N, and then return a write status packet to the SPI interface module 200b, including:
when the execution result of each write command contained in the write command packet is successful, the functional module 300 returns a write status packet with successful status information to the SPI interface module 200b;
when the execution result of at least one write command contained in the write command packet is failed, the functional module 300 returns a write status packet with failed status information to the SPI interface module 200b.

In the present invention, when the SPI interface module 200b sends the write command packet to the functional module 300, it can modify, add or delete the content in the write command packet, which is not limited or specified by the present invention.

The functional modules 300 receiving the write command packet return the write status packet to the SPI interface module 200b, and the SPI interface module 200b receives the write status packet from each functional module 300 to which it sends the write command packet and returns the status information of the write status packet to the SPI master controller 100b, including:

After receiving the write status packet from each functional module 300 to which it sends the write command packet, the SPI interface module 200b sends a write feedback packet to the SPI master controller 100b via the SPI_MISO signal line when the SPI master controller 100b generates a clock edge on the SPI_CK, where the write feedback packet starts with a second identifier and contains the status information of the write status packet.

As shown in the embodiment in FIG. 14, it is a data structure of a write command packet when the master controller 100 is an SPI master controller 100b and the interface module 200 is an SPI interface module 200b of the present invention. Four embodiments of the write command packet are exemplarily given in the embodiment:

The write command packet may include a first identifier and write command 1, write command 2, . . . , write command N, and start with the first identifier; the write command packet may also include a first identifier, a write command packet length field and write command 1, write command 2, . . . , write command N, and start with the first identifier;
the write command packet may also include a first identifier, a remote I2C address, write command 1, write command 2, . . . , write command N, and start with the first identifier; the write command packet may also include a first identifier, a write command packet length field, a remote I2C address, write command 1, write command 2, . . . , write command N, and start with the first identifier.

The first identifier, the write command packet length field (if present), the remote I2C address (if present), write command 1, write command 2, . . . , write command N contained in the write command packet are composed of binary bit sequences, and the present invention does not limit the length of the binary bit sequences of the first identifier, the write command packet length field (if present), the remote I2C address (if present), write command 1, write command 2, . . . , write command N.

It should be noted that the present invention does not limit the format of the write command packet, that is, the format of the write command packet in the present invention is not limited to the four embodiments of the write command packet shown in FIG. 14. The SPI master controller 100b and the SPI interface module 200b can agree on other formats of the write command packet.

In the present invention, the SPI interface module 200b receiving the write command packet means that the data received by the SPI interface module 200b from the SPI_MOSI signal line contains a complete write command packet. As shown in FIG. 14, the write command packet may contain a write command packet length field, and the SPI interface module 200b can determine whether the received data contains a complete write command packet based on the write command packet length field (or partially based on the write command packet length field) according to the agreement with the SPI master controller 100b. As shown in FIG. 14, the write command packet may also not contain a write command packet length field; in this case, the SPI interface module 200b determines whether the received data contains a complete write command packet according to the agreement with the SPI master controller 100b (the agreement is not based on the write command packet length field).

The SPI master controller 100b drives the SPI_CK signal line and generates clock edges on the SPI_CK signal line, samples data on the SPI_MISO signal line at the clock rising edge or falling edge on the SPI_CK signal line, and the SPI interface module 200b samples data on the SPI_MOSI signal line at the clock rising edge or falling edge on the SPI_CK signal line, to realize bidirectional data transmission between the SPI master controller 100b and the SPI interface module 200b.

The present invention does not limit the sampling of data on the SPI_MISO signal line and the SPI_MOSI signal line at the clock rising edge or falling edge on the SPI_CK signal line. In the embodiments described below in the present invention, data on the SPI_MISO signal line and the SPI_MOSI signal line is sampled at the clock rising edge on the SPI_CK signal line, i.e., the clock rising edge on the SPI_CK signal line is a sampling clock edge in the embodiments described below in the present invention. In other embodiments of the present invention, data on the SPI_MISO signal line and the SPI_MOSI signal line may also be sampled at the clock falling edge on the SPI_CK signal line, i.e., the clock falling edge on the SPI_CK signal line is a sampling clock edge in these embodiments.

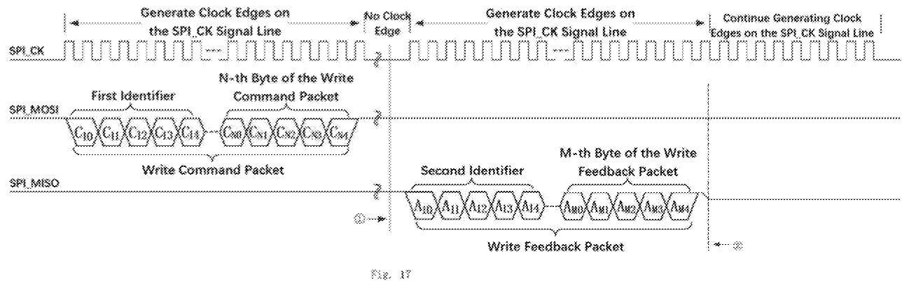

As shown in FIG. 15, the SPI master controller 100b generates clock edges on the SPI_CK signal line and drives the SPI_MOSI signal line simultaneously, sending the write command packet to the SPI interface module 200b via the SPI_MOSI signal line. The write command packet contains N bytes, with each byte being 8-bit binary data. The first byte is the first identifier, whose 8-bit binary data is denoted as C10, C11 . . . C17; the Nth byte is the last byte of the write command packet, whose 8-bit binary data is denoted as CN0, CN1 . . . CN7.

The SPI interface module 200b samples the data on the SPI_MOSI signal line at the rising clock edge of the SPI_CK signal line to receive the write command packet from the SPI_MOSI signal line. When the SPI interface module 200b samples the CN7 bit, the data received from the SPI_MOSI signal line contains the complete write command packet, meaning the SPI interface module 200b has received the write command packet.

After receiving the write command packet from the SPI_MOSI signal line, the SPI interface module 200b sends the write command packet to the functional module 300. In the present invention, the SPI interface module 200b may modify, add or delete the content in the write command packet when sending it to the functional module 300, and the present invention imposes no restrictions or provisions on this operation.

The functional module 300 that receives the write command packet executes one or more write commands contained in the write command packet (i.e., Write Command 1, Write Command 2, . . . , Write Command N), and then returns a write status packet to the SPI interface module 200b, including:

If the execution result of each write command contained in the write command packet is successful, the functional module 300 returns a write status packet with successful status information to the SPI interface module 200b;

If the execution result of at least one write command contained in the write command packet is failed, the functional module 300 returns a write status packet with failed status information to the SPI interface module 200b.

At time \textcircled{1}, the SPI interface module 200b receives the write status packet. The SPI master controller 100b generates clock edges on the SPI_CK signal line, and the SPI interface module 200b drives the SPI_MISO signal line to send a write feedback packet via the SPI_MISO signal line. The SPI master controller 100b samples the data on the SPI_MISO signal line at the rising clock edge of the SPI_CK signal line to read the write feedback packet. The write feedback packet starts with a second identifier and contains the status information of the write status packet; the status information in the write status packet may indicate write success or failure, or other status information. In one embodiment, the write feedback packet may separately contain the success or failure information of each write status packet received by the SPI interface module 200b. After receiving the write feedback packet, the SPI master controller 100b can learn the execution status of the write command packet by each functional module 300 that received the write command packet according to the write feedback packet, and further perform subsequent processing based on the execution status.

The write feedback packet contains M bytes, with each byte being 8-bit binary data. The first byte is the second identifier, whose 8-bit binary data is denoted as A10, A11 . . . A17; the Mth byte is the last byte of the write feedback packet, whose 8-bit binary data is denoted as AM0, AM1 . . . AM7.

For ease of understanding, the embodiment shown in FIG. 15 and the following descriptions of the present invention describe each byte as 8-bit binary data, but the present invention does not limit the number of bits of each byte, and each byte may also have other bit lengths.

In the embodiment shown in FIG. 15, the first identifier and the second identifier are each one byte in length, and the write command packet and the write feedback packet are integer multiples of a byte in length. For ease of understanding, in the following descriptions of the present invention, the first to fourth identifiers are each one byte in length, and the write command packet and the write feedback packet (including the write success feedback packet and the write failure feedback packet) are integer multiples of a byte in length. However, the present invention does not limit the first to fourth identifiers to be one byte in length, nor does it limit them to be integer multiples of a byte in length; the present invention also does not limit the write command packet and the write feedback packet (including the write success feedback packet and the write failure feedback packet) to be integer multiples of a byte in length.

In the interval marked “No clock edge”, the SPI master controller 100b does not generate sampling clock edges on the SPI_CK signal line. In FIG. 15 and the descriptions of subsequent embodiments of the present invention, the levels on the SPI_MOSI and SPI_MISO signal lines remain unchanged in the “No clock edge” interval. The present invention does not limit the levels on the SPI_MOSI and SPI_MISO signal lines in this interval, and the levels on the SPI_MOSI and SPI_MISO signal lines may also change therein. However, since the sampling of data on the SPI_MOSI and SPI_MISO signal lines is only performed at the sampling clock edges on the SPI_CK signal line (the sampling clock edge is the rising clock edge in the embodiment shown in FIG. 15), changes in the levels on the SPI_MOSI and SPI_MISO signal lines in the “No clock edge” interval will not be sampled and received.

In the embodiment shown in FIG. 15, when the SPI master controller 100b generates clock edges on the SPI_CK signal line and drives the SPI_MOSI signal line simultaneously to send the write command packet via the SPI_MOSI signal line, the SPI interface module 200b has no write feedback packet to send, and at this time, the SPI interface module 200b drives the SPI_MISO signal line to a high level. During this period, the SPI interface module 200b in the present invention may also drive the SPI_MISO signal line to a low level or a varying level, but the SPI interface module 200b shall ensure that the level value or varying level driven by it on the SPI_MISO signal line will not be recognized as the second identifier if sampled by the SPI master controller 100b at the sampling clock edge on the SPI_CK signal line (the sampling clock edge is the rising clock edge in the embodiment shown in FIG. 15). Taking the embodiment shown in FIG. 15 as an example, since the SPI interface module 200b drives the SPI_MISO signal line to a high level (sampled as continuous binary bit 1) during this period, the value of the second identifier should not be 0xFF to avoid being recognized as such.

In the embodiment shown in FIG. 15, when the SPI master controller 100b generates clock edges on the SPI_CK signal line and the SPI interface module 200b drives the SPI_MISO signal line to send the write feedback packet via the SPI_MISO signal line, the SPI master controller 100b has no write command packet to send, and at this time, the SPI master controller 100b drives the SPI_MOSI signal line to a high level. During this period, the SPI master controller 100b in the present invention may also drive the SPI_MOSI signal line to a low level or a varying level, but the SPI master controller 100b shall ensure that the level value or varying level driven by it on the SPI_MOSI signal line will not be recognized as the first identifier if sampled by the SPI interface module 200b at the sampling clock edge on the SPI_CK signal line (the sampling clock edge is the rising clock edge in the embodiment shown in FIG. 15). Taking the embodiment shown in FIG. 15 as an example, since the SPI master controller 100b drives the SPI_MOSI signal line to a high level (sampled as continuous binary bit 1) during this period, the value of the first identifier should not be 0xFF to avoid being recognized as such.

In addition to the SPI_CK, SPI_MOSI and SPI_MISO signal lines, the SPI interface module 200b may also be connected to the SPI master controller 100b via an SPI_CSN signal line. The SPI master controller 100b drives the SPI_CSN, SPI_CK and SPI_MOSI signal lines, and the SPI interface module 200b receives these three signal lines; the SPI interface module 200b drives the SPI_MISO signal line, and the SPI master controller 100b receives this signal line. The SPI_CSN signal line is a chip select signal; in the SPI protocol, data transmission is performed only when the SPI_CSN signal line is at a low level. One SPI master controller 100b can be connected to multiple SPI interface modules 200b, where the SPI master controller 100b and the multiple SPI interface modules 200b share the SPI_CK, SPI_MOSI and SPI_MISO signal lines, but each SPI interface module 200b has an independent SPI_CSN signal line input. When the SPI_CSN signal line of an SPI interface module 200b is at a high level, the SPI interface module 200b does not drive the SPI_MISO signal line (the driver of the SPI interface module 200b connected to the SPI_MISO signal line outputs a Hi-Z state), and an SPI interface module 200b drives the SPI_MISO signal line only when its SPI_CSN signal line is at a low level. When one SPI master controller 100b is connected to multiple SPI interface modules 200b, only the SPI_CSN signal line of one SPI interface module 200b is at a low level at any time, thus avoiding conflicts caused by multiple SPI interface modules 200b driving the SPI_MISO signal line simultaneously.

When one SPI master controller 100b is connected to only one SPI interface module 200b, the SPI interface module 200b can drive the SPI_MISO signal line at any time without causing conflicts. In this case, there may be no SPI_CSN signal line between the SPI master controller 100b and the SPI interface module 200b, that is, when one SPI master controller 100b is connected to only one SPI interface module 200b, the two can be connected only via the SPI_CK, SPI_MOSI and SPI_MISO signal lines, which is the case described in the embodiment shown in FIG. 15 above.

The present invention only describes the scenario where there is no SPI_CSN signal line between the SPI master controller 100b and the SPI interface module 200b, but based on the description of the present invention, it can be easily extended to the scenario where an SPI_CSN signal line exists between them, and the present invention will not elaborate on the latter scenario. Whether an SPI_CSN signal line exists between the SPI master controller 100b and the SPI interface module 200b, it falls within the protection scope of the present invention.

According to an embodiment of the present invention, the SPI master controller 100b generates clock edges on the SPI_CK signal line to read the write feedback packet via the SPI_MISO signal line;
if the SPI interface module 200b does not receive the write status packet from each functional module 300 to which it sent the write command packet, the SPI interface module 200b sends data that cannot be recognized as the write feedback packet to the SPI master controller 100b via the SPI_MISO signal line.

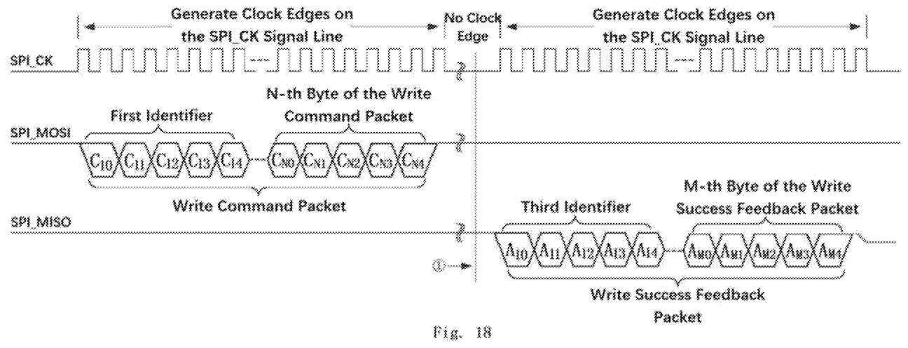

Taking FIG. 16 as an example, the SPI master controller 100b generates clock edges on the SPI_CK signal line to send the write command packet to the SPI interface module 200b via the SPI_MOSI signal line. After receiving the write command packet from the SPI_MOSI signal line, the SPI interface module 200b sends the write command packet to one or more functional modules 300. The functional module 300 that receives the write command packet executes one or more write commands contained in the write command packet, and then returns a write status packet to the SPI interface module 200b. At time \textcircled{3}, the SPI interface module 200b receives the write status packet from each functional module 300 to which it sent the write command packet. Before time \textcircled{3} (when the SPI interface module 200b receives the write status packet from each of these functional modules 300), between time \textcircled{1} and time \textcircled{2}, the SPI master controller 100b generates clock edges on the SPI_CK signal line. In the embodiment shown in FIG. 16, the SPI interface module 200b drives the SPI_MISO signal line to a high level during this period. The SPI interface module 200b may also drive the SPI_MISO signal line to a low level or a varying level, but it shall ensure that the level value or varying level driven by it on the SPI_MISO signal line will not be recognized as the second identifier if sampled by the SPI master controller 100b at the sampling clock edge on the SPI_CK signal line (the sampling clock edge is the rising clock edge in the embodiment shown in FIG. 16). That is, if the SPI interface module 200b has not received the write status packet from each functional module 300 to which it sent the write command packet and the SPI master controller 100b generates clock edges on the SPI_CK signal line, the SPI interface module 200b sends data that cannot be recognized as the write feedback packet to the SPI master controller 100b via the SPI_MISO signal line. After the SPI interface module 200b receives the write status packet from each functional module 300 to which it sent the write command packet at time \textcircled{3}, the SPI master controller 100b generates clock edges on the SPI_CK signal line and reads the write feedback packet from the SPI interface module 200b via the SPI_MISO signal line.

In the embodiment shown in FIG. 17, the SPI master controller 100b generates clock edges on the SPI_CK signal line to send the write command packet to the SPI interface module 200b via the SPI_MOSI signal line. After receiving the write command packet from the SPI_MOSI signal line, the SPI interface module 200b sends the write command packet to one or more functional modules 300. The functional module 300 that receives the write command packet executes one or more write commands contained in the write command packet, and then returns a write status packet to the SPI interface module 200b. At time \textcircled{1}, the SPI interface module 200b receives the write status packet from each functional module 300 to which it sent the write command packet, and the SPI master controller 100b generates clock edges on the SPI_CK signal line to read the write feedback packet from the SPI interface module 200b via the SPI_MISO signal line. At time \textcircled{2}, the SPI master controller 100b completes reading the write feedback packet, and the SPI interface module 200b completes sending the write feedback packet. The SPI master controller 100b continues to generate clock edges on the SPI_CK signal line, and at this time, the SPI interface module 200b drives the SPI_MISO signal line to a high level. During this period, the SPI interface module 200b may also drive the SPI_MISO signal line to a low level or a varying level, but it shall ensure that the level value or varying level driven by it on the SPI_MISO signal line will not be recognized as the second identifier if sampled by the SPI master controller 100b at the sampling clock edge on the SPI_CK signal line (the sampling clock edge is the rising clock edge in the embodiment shown in FIG. 17).

According to an embodiment of the present invention, the SPI master controller 100b generates clock edges on the SPI_CK signal line to send the write command packet to the SPI interface module 200b via the SPI_MOSI signal line; then the SPI master controller 100b generates clock edges on the SPI_CK signal line to read the write feedback packet via the SPI_MISO signal line. After sending the write feedback packet via the SPI_MISO signal line, the SPI interface module 200b can continue to receive subsequent command packets (the subsequent command packets include write command packets and read command packets).

In the present invention, the SPI master controller 100b generates clock edges on the SPI_CK signal line to send the write command packet to the SPI interface module 200b via the SPI_MOSI signal line.

After receiving the write command packet from the SPI_MOSI signal line, the SPI interface module 200b sends the write command packet to one or more functional modules 300. The functional module 300 that receives the write command packet executes one or more write commands contained in the write command packet, and then returns a write status packet to the SPI interface module 200b. Then the SPI master controller 100b generates clock edges on the SPI_CK signal line to read the write feedback packet via the SPI_MISO signal line. Before the SPI master controller 100b reads the write feedback packet, if the SPI master controller 100b drives the SPI_MOSI signal line to send command packets (including write command packets and read command packets), the SPI interface module 200b may choose not to receive the command packets sent by the SPI master controller 100b before the read operation of the write feedback packet. After the SPI master controller 100b reads the write feedback packet (i.e., after the SPI interface module 200b sends the write feedback packet via the SPI_MISO signal line), the SPI interface module 200b can continue to receive subsequent command packets (the subsequent command packets include write command packets and read command packets).

According to an embodiment of the present invention, the write feedback packet is divided into a write success feedback packet and a write failure feedback packet.

The SPI master controller 100b generates clock edges on the SPI_CK signal line to read the write feedback packet via the SPI_MISO signal line:

If the SPI interface module 200b receives the write status packet from each functional module 300 to which it sent the write command packet and the status information of each write status packet is successful, the SPI interface module 200b sends the write success feedback packet via the SPI_MISO signal line, and the write success feedback packet starts with a third identifier;

If the SPI interface module 200b receives the write status packet from each functional module 300 to which it sent the write command packet and the status information of at least one write status packet is failed, the SPI interface module 200b sends the write failure feedback packet via the SPI_MISO signal line, and the write failure feedback packet starts with a fourth identifier.

As shown in FIG. 18, the SPI master controller 100b generates clock edges on the SPI_CK signal line to send the write command packet to the SPI interface module 200b via the SPI_MOSI signal line. After receiving the write command packet from the SPI_MOSI signal line, the SPI interface module 200b sends the write command packet to one or more functional modules 300. The functional module 300 that receives the write command packet executes one or more write commands contained in the write command packet, and then returns a write status packet to the SPI interface module 200b. At time \textcircled{1}, the SPI interface module 200b receives the write status packet from each functional module 300 to which it sent the write command packet, and the status information of each write status packet is successful. When the SPI master controller 100b generates clock edges on the SPI_CK signal line to read the write feedback packet from the SPI interface module 200b via the SPI_MISO signal line, the SPI interface module 200b drives the SPI_MISO signal line to send the write success feedback packet to the SPI master controller 100b via the SPI_MISO signal line, and the write success feedback packet starts with the third identifier.

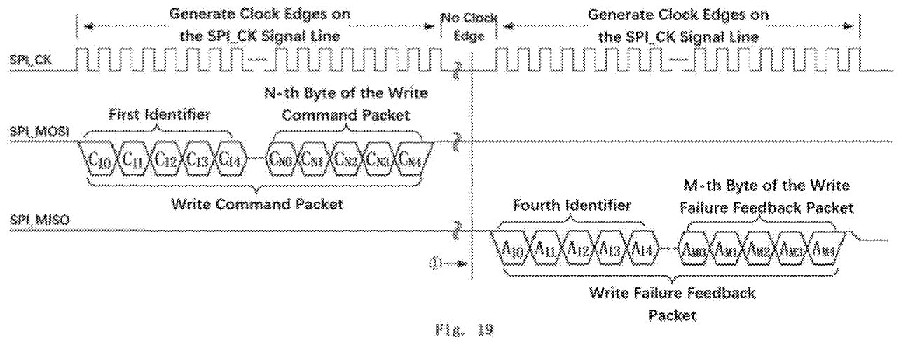

As shown in FIG. 19, the SPI master controller 100b generates clock edges on the SPI_CK signal line to send the write command packet to the SPI interface module 200b via the SPI_MOSI signal line. After receiving the write command packet from the SPI_MOSI signal line, the SPI interface module 200b sends the write command packet to one or more functional modules 300. The functional module 300 that receives the write command packet executes one or more write commands contained in the write command packet, and then returns a write status packet to the SPI interface module 200b. At time \textcircled{1}, the SPI interface module 200b receives the write status packet from each functional module 300 to which it sent the write command packet, and the status information of at least one write status packet is failed. When the SPI master controller 100b generates clock edges on the SPI_CK signal line to read the write feedback packet from the SPI interface module 200b via the SPI_MISO signal line, the SPI interface module 200b drives the SPI_MISO signal line to send the write failure feedback packet to the SPI master controller 100b via the SPI_MISO signal line, and the write failure feedback packet starts with the fourth identifier.

In the present invention, the third identifier is different from the fourth identifier. The SPI master controller 100b can judge whether the read write feedback packet is a write success feedback packet or a write failure feedback packet according to whether the write feedback packet starts with the third identifier or the fourth identifier. Therefore, the write success feedback packet may only contain the third identifier, and the write failure feedback packet may only contain the fourth identifier, which enables the SPI master controller 100b to distinguish the read write feedback packet as a write success feedback packet or a write failure feedback packet.

In the present invention, the master controller 100 is not limited to the I2C master controller 100a and the SPI master controller 100b, but may also be a master controller complying with other interface protocols (e.g., a master controller complying with the UART, CAN, LIN and other serial port protocols). Similarly, the interface module 200 is not limited to the I2C interface module 200a and the SPI interface module 200b, but may also be an interface module complying with other interface protocols (e.g., an interface module complying with the UART, CAN, LIN and other serial port protocols). The use of a master controller and an interface module complying with other interface protocols also falls within the protection scope of the present invention.

According to an embodiment of the present invention, the master controller 100 (an I2C master controller 100a, an SPI master controller 100b or a master controller complying with other interface protocols) sends a write command packet to the interface module 200 (an I2C interface module 200a, an SPI interface module 200b or an interface module complying with other interface protocols). After receiving the write command packet, the interface module 200 sends the write command packet to one or more functional modules 300. The write command packet contains one or more write commands, as shown in FIGS. 2 and 14.

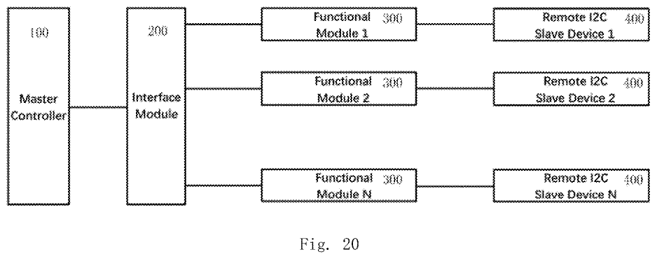

As shown in FIG. 20, an embodiment of the present invention provides an interface system, which is characterized in that the interface system includes a master controller 100, an interface module 200, a plurality of functional modules 300 and a remote I2C slave device 400. The master controller 100 is connected to the interface module 200, and the interface module 200 is connected to the plurality of functional modules 300 (numbered 1 to N). The functional module 300 may or may not be connected to the remote I2C slave device 400.

As shown in FIG. 20, all functional modules 300 are connected to the remote I2C slave device 400; alternatively, the functional module 300 may not be connected to multiple remote I2C slave devices 400, or may be connected to multiple remote I2C slave devices 400.

In this example, the process in which the master controller 100 sends the write command packet, the interface module 200 receives the write command packet and sends it to one or more functional modules 300 is the same as that in the embodiment and description shown in FIG. 1, and will not be repeated here.

In this example, the functional module 300 that receives the write command packet is connected to the remote I2C slave device 400. After receiving the write command packet from the interface module 200, the functional module 300 executes one or more write commands contained in the write command packet, and the method for executing each write command is as follows:

The functional module 300 sends an I2C START to the remote I2C slave device 400, then sends a remote I2C address byte to the remote I2C slave device 400, and then sends a write command to the remote I2C slave device 400. For each byte sent by the functional module 300 to the remote I2C slave device 400, the functional module 300 receives an I2C acknowledgment bit sent by the remote I2C slave device 400 and determines the execution result of the write command.

After executing one or more write commands contained in the write command packet, the functional module 300 that receives the write command packet returns a write status packet to the interface module 200, including:

If the execution result of each write command contained in the write command packet is successful, the functional module 300 returns a write status packet with successful status information to the interface module 200;

If the execution result of at least one write command contained in the write command packet is failed, the functional module 300 returns a write status packet with failed status information to the interface module 200.

The interface module 200 receives the write status packet from each functional module 300 to which it sent the write command packet, and returns the status information of the write status packet to the master controller 100.

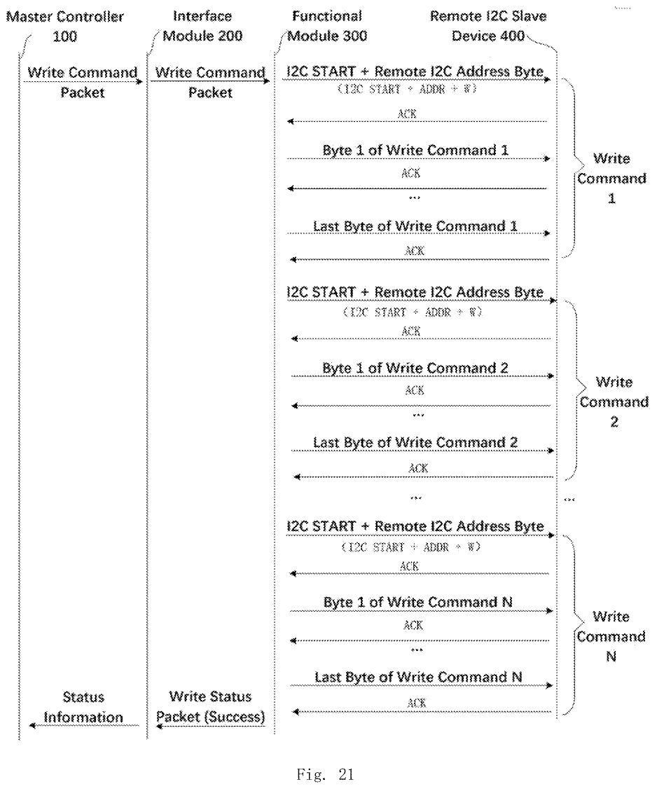

As shown in FIG. 21, for each write command (Write Command 1, Write Command 2, . . . , Write Command N) contained in the write command packet, the functional module 300 first sends an I2C START to the remote I2C slave device 400, then sends a remote I2C address byte to the remote I2C slave device 400, and then the functional module 300 sends a write command to the remote I2C slave device 400. The remote I2C address byte consists of an I2C address (ADDR) and a write operation indicator bit (W).

For a single write command, if the functional module 300 receives an I2C ACK as the acknowledgment bit after sending the remote I2C address byte, and receives an I2C ACK as the acknowledgment bit after sending each byte of the write command, the execution result of the write command by the functional module 300 is successful.

As shown in FIG. 21, if the execution result of each write command is successful, the functional module 300 returns a write status packet with successful status information to the interface module 200, and the interface module 200 returns the status information of the write status packet to the master controller 100.

In other embodiments (not shown in FIG. 21), the functional module 300 may also agree with the remote I2C slave device 400 that for a single write command, the execution result is deemed successful if the functional module 300 receives an I2C ACK as the acknowledgment bit after sending the remote I2C address byte, receives an I2C ACK as the acknowledgment bit after sending each byte of the write command except the last one, and receives an I2C NAK as the acknowledgment bit after sending the last byte of the write command.

If the execution result of a single write command is failed, the functional module 300 stops executing subsequent write commands, and returns a write status packet with failed status information to the interface module 200, and the interface module 200 returns the status information of the write status packet to the master controller 100.

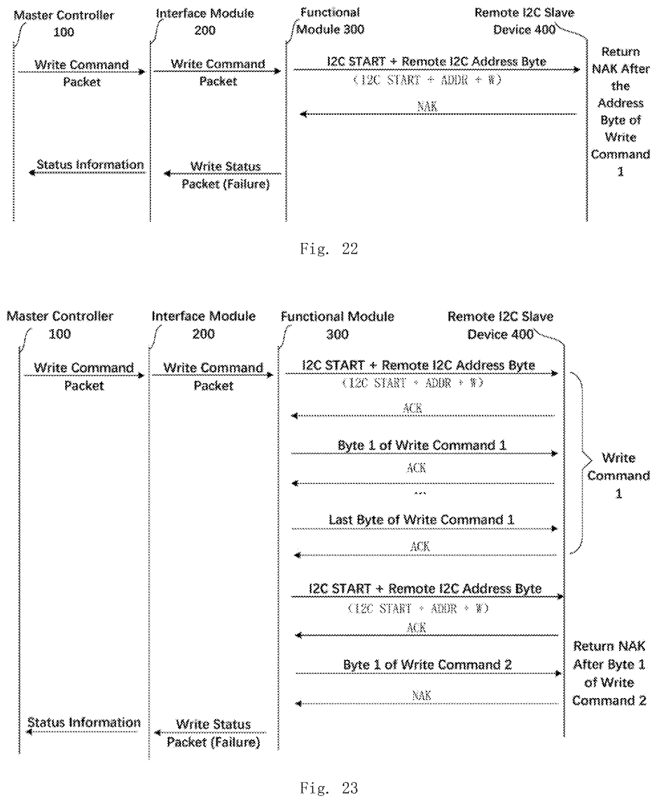

As shown in FIG. 22, after the functional module 300 sends the remote I2C address byte (the address byte of Write Command 1) to the remote I2C slave device 400, it receives an I2C NAK as the acknowledgment bit sent by the remote I2C slave device 400, and the execution result of Write Command 1 is failed. The functional module 300 stops executing subsequent write commands, returns a write status packet with failed status information to the interface module 200, and the interface module 200 returns the status information of the write status packet to the master controller 100.

As shown in FIG. 23, another embodiment of write command execution failure is provided. The functional module 300 receives an I2C ACK as the acknowledgment bit after sending the remote I2C address byte, and receives an I2C ACK as the acknowledgment bit after sending each byte of Write Command 1, so the execution result of Write Command 1 by the functional module 300 is successful. Then for Write Command 2, the functional module 300 receives an I2C ACK as the acknowledgment bit after sending the remote I2C address byte, but receives an I2C NAK as the acknowledgment bit sent by the remote I2C slave device 400 after sending Byte 1 of Write Command 2, so the execution result of Write Command 2 is failed (in this embodiment, either Byte 1 of Write Command 2 is not the last byte of Write Command 2, or Byte 1 of Write Command 2 is the last byte but the functional module 300 and the remote I2C slave device 400 agree that the write command is deemed successfully executed only if an I2C ACK is received as the acknowledgment bit after sending each byte of the write command). Therefore, since the execution result of at least one write command contained in the write command packet is failed, the functional module 300 returns a write status packet with failed status information to the interface module 200, and the interface module 200 returns the status information of the write status packet to the master controller 100.

If the execution result of at least one write command contained in the write command packet is failed, the functional module 300 returns a write status packet with failed status information to the interface module 200, and the interface module 200 returns the status information of the write status packet to the master controller 100.

In the present invention, the status information of the write status packet may separately contain the success or failure information of each write status packet received by the interface module 200. After receiving the status information, the master controller 100 can learn the execution status of the write command packet by each functional module 300 that received the write command packet according to the status information, and further perform subsequent processing based on the execution status.

In the embodiments shown in FIGS. 22 and 23, if the execution result of a single write command is failed, the functional module 300 stops executing subsequent write commands, returns a write status packet with failed status information to the interface module 200, and the interface module 200 returns the status information of the write status packet to the master controller 100. In other embodiments, if the execution result of a single write command is failed, the functional module 300 may choose to continue executing the subsequent write commands contained in the write command packet; however, if the execution result of at least one write command contained in the write command packet is failed, the functional module 300 returns a write status packet with failed status information to the interface module 200, and the interface module 200 returns the status information of the write status packet to the master controller 100.

In a preferred embodiment, the functional module 300 includes a remote I2C address register, and the I2C address contained in the remote I2C address byte sent by the functional module 300 (that receives the write command packet) to the remote I2C slave device 400 (the ADDR shown in FIGS. 21, 22 and 23) is the remote I2C address stored in the remote I2C address register.

In a preferred embodiment, the write command packet contains a remote I2C address (the write command packet containing a remote I2C address as shown in Fig. s 2 and 14), and the I2C address contained in the remote I2C address byte sent by the functional module 300 (that receives the write command packet) to the remote I2C slave device 400 is the remote I2C address contained in the write command packet.

Further, the functional module 300 includes a remote I2C address register and a remote I2C address selection module. The I2C address contained in the remote I2C address byte sent by the functional module 300 (that receives the write command packet) to the remote I2C slave device 400 is derived from the remote I2C address stored in the remote I2C address register or the remote I2C address contained in the write command packet according to the instruction of the remote I2C address selection module.

In a preferred embodiment, each of the multiple write commands in the write command packet contains an independent remote I2C address, and the remote I2C address contained in the remote I2C address byte sent by the functional module 300 to the remote I2C slave device is derived from the independent remote I2C address contained in each respective write command.

As shown in FIG. 3, in another embodiment, the master controller 100 is an I2C master controller 100a, and the interface module 200 is an I2C interface module 200a. The I2C master controller 100a initiates an I2C write operation to send a write command packet to the I2C interface module 200a, and then initiates a subsequent I2C read operation to read status information.

In this example, the I2C master controller 100a will inevitably initiate a subsequent I2C read operation to read status information after initiating an I2C write operation to send the write command packet to the I2C interface module 200a.

After receiving the address byte of the subsequent I2C read operation, the I2C interface module 200a pulls down the level of the I2C clock line and sends the received write command packet to one or more functional modules 300.

The functional module 300 that receives the write command packet executes one or more write commands contained in the write command packet, and returns a write status packet to the I2C interface module 200a, including:

If the execution result of each write command contained in the write command packet is successful, the functional module 300 returns a write status packet with successful status information to the I2C interface module 200a;

If the execution result of at least one write command contained in the write command packet is failed, the functional module 300 returns a write status packet with failed status information to the I2C interface module 200a.

After receiving the write status packet from each functional module 300 to which it sent the write command packet, the I2C interface module 200a stops pulling down the level of the I2C clock line and returns the status information of the write status packet to the I2C master controller 100a.

Although the embodiments of the present invention have been shown and described above, it should be understood that the above embodiments are exemplary and should not be construed as limitations of the present invention. Variations, modifications, substitutions and alterations to the above embodiments made by those of ordinary skill in the art within the scope of the present invention shall all fall within the protection scope of the present invention.

What is claimed is:

1. A multi-target data writing method based on an interface system, where the interface system includes a master controller, an interface module and a plurality of functional modules, the master controller is connected to the interface module, and the interface module is connected to the plurality of functional modules, characterized in that:
The master controller sends a write command packet to the interface module, and after receiving the write command packet, the interface module sends the write command packet to one or more functional modules;
the functional modules that receive the write command packet execute one or more write commands contained in the write command packet and return a write status packet to the interface module, including:
if the execution result of each write command contained in the write command packet is successful, the functional module returns a write status packet with successful status information to the interface module;
if the execution result of at least one write command contained in the write command packet is failed, the functional module returns a write status packet with failed status information to the interface module;
the interface module receives the write status packet from each functional module to which it sent the write command packet, and returns the status information of the write status packet to the master controller.

2. The multi-target data writing method according to claim 1, characterized in that the master controller is an I2C master controller, and the interface module is an I2C interface module;
the I2C master controller is connected to the I2C interface module via an I2C clock line and an I2C data line, initiates an I2C write operation to send the write command packet to the I2C interface module; after receiving the write command packet, the I2C interface module pulls down the level of the I2C clock line and sends the write command packet to one or more functional modules;
the functional modules that receive the write command packet return the write status packet to the I2C interface module; the I2C interface module receives the write status packet from each functional module to which it sent the write command packet, and returns the status information of the write status packet to the I2C master controller.

3. The multi-target data writing method according to claim 2, characterized in that:
if the I2C interface module receives the write status packet from each functional module to which it sent the write command packet and the status information of each write status packet is successful, the I2C interface module stops pulling down the level of the I2C clock line and returns an I2C ACK to the I2C master controller;
if the I2C interface module receives the write status packet from each functional module to which it sent the write command packet and the status information of at least one write status packet is failed, the I2C interface module stops pulling down the level of the I2C clock line and returns an I2C NAK to the I2C master controller.

4. The multi-target data writing method according to claim 2, characterized in that:
after the I2C interface module receives the write status packet from each functional module to which it sent the write command packet, it stops pulling down the level of the I2C clock line and returns an I2C ACK or an I2C NAK to the I2C master controller;
if a subsequent I2C operation initiated by the I2C master controller is an I2C read operation, the I2C interface module returns the status information of the write status packet to the I2C master controller.

5. The multi-target data writing method according to claim 1, characterized in that the master controller is an I2C master controller, and the interface module is an I2C interface module;
the I2C master controller is connected to the I2C interface module via an I2C clock line and an I2C data line, initiates an I2C write operation to send the write command packet to the I2C interface module; after receiving the write command packet, the I2C interface module sends the write command packet to one or more functional modules;
the functional modules that receive the write command packet return the write status packet to the I2C interface module;
after the I2C interface module receives the write command packet:
if a subsequent I2C operation initiated by the I2C master controller is an I2C read operation, and the I2C interface module receives the write status packet from each functional module to which it sent the write command packet, the I2C interface module returns the status information of the write status packet to the I2C master controller.

6. The multi-target data writing method according to claim 5, characterized in that if the subsequent I2C operation initiated by the I2C master controller is an I2C write operation:
if the I2C interface module receives the write status packet from each functional module to which it sent the write command packet and the status information of each write status packet is successful, the I2C interface module receives the subsequent I2C write operation initiated by the I2C master controller;
if the I2C interface module receives the write status packet from each functional module to which it sent the write command packet and the status information of at least one write status packet is failed, the I2C interface module returns an I2C NAK to the I2C master controller.

7. The multi-target data writing method according to claim 1, characterized in that the master controller is an SPI master controller, and the interface module is an SPI interface module; the SPI master controller is connected to the SPI interface module via an SPI_CK signal line, an SPI_MOSI signal line and an SPI_MISO signal line;
the SPI master controller generates clock edges on the SPI_CK signal line and sends the write command packet to the SPI interface module via the SPI_MOSI signal line, with the write command packet starting with a first identifier; after receiving the write command packet from the SPI_MOSI, the SPI interface module sends the write command packet to one or more functional modules;
the functional modules that receive the write command packet return the write status packet to the SPI interface module; the SPI interface module receives the write status packet from each functional module to which it sent the write command packet and returns the status information of the write status packet to the SPI master controller, including:
after receiving the write status packet from each functional module to which it sent the write command packet, the SPI interface module sends a write feedback packet to the SPI master controller via the SPI_MISO signal line when the SPI master controller generates a clock edge on the SPI_CK, with the write feedback packet starting with a second identifier and containing the status information of the write status packet.

8. The multi-target data writing method according to claim 7, characterized in that:
the SPI master controller generates clock edges on the SPI_CK signal line to read the write feedback packet via the SPI_MISO signal line;
if the SPI interface module does not receive the write status packet from each functional module to which it sent the write command packet, the SPI interface module sends data that cannot be recognized as the write feedback packet to the SPI master controller via the SPI_MISO signal line.

9. The multi-target data writing method according to claim 7, characterized in that:
the SPI master controller generates clock edges on the SPI_CK signal line and sends the write command packet to the SPI interface module via the SPI_MOSI signal line;
then the SPI master controller generates clock edges on the SPI_CK signal line to read the write feedback packet via the SPI_MISO signal line; after sending the write feedback packet via the SPI_MISO signal line, the SPI interface module can continue to receive subsequent command packets.

10. The multi-target data writing method according to claim 7, characterized in that the write feedback packet is divided into a write success feedback packet and a write failure feedback packet;
the SPI master controller generates clock edges on the SPI_CK signal line to read the write feedback packet via the SPI_MISO signal line;
if the SPI interface module receives the write status packet from each functional module to which it sent the write command packet and the status information of each write status packet is successful, the SPI interface module sends the write success feedback packet via the SPI_MISO signal line, with the write success feedback packet starting with a third identifier;
if the SPI interface module receives the write status packet from each functional module to which it sent the write command packet and the status information of at least one write status packet is failed, the SPI interface module sends the write failure feedback packet via the SPI_MISO signal line, with the write failure feedback packet starting with a fourth identifier.

11. The multi-target data writing method according to claim 1, characterized in that the functional module that receives the write command packet is connected to a remote I2C slave device; after receiving the write command packet from the interface module, the functional module executes one or more write commands contained in the write command packet, and the method for executing each write command is as follows:
the functional module sends an I2C START to the remote I2C slave device, then sends a remote I2C address byte to the remote I2C slave device, and then sends a write command to the remote I2C slave device;
for each byte sent by the functional module to the remote I2C slave device, the functional module receives an I2C acknowledgment bit sent by the remote I2C slave device and determines the execution result of the write command.

12. The multi-target data writing method according to claim 11, characterized in that the functional module that receives the write command packet includes a remote I2C address register, and the I2C address contained in the remote I2C address byte sent by the functional module to the remote I2C slave device is the remote I2C address stored in the remote I2C address register.

13. The multi-target data writing method according to claim 11, characterized in that the write command packet contains a remote I2C address, and the I2C address contained in the remote I2C address byte sent by the functional module to the remote I2C slave device is the remote I2C address contained in the write command packet.

14. The multi-target data writing method according to claim 13, characterized in that the functional module that receives the write command packet includes a remote I2C address register and a remote I2C address selection module; the I2C address contained in the remote I2C address byte sent by the functional module to the remote I2C slave device is derived from the remote I2C address stored in the remote I2C address register or the remote I2C address contained in the write command packet according to the instruction of the remote I2C address selection module.

15. A multi-target data writing method based on an interface system, where the interface system includes an I2C master controller, an I2C interface module and a plurality of functional modules, the I2C master controller is connected to the I2C interface module, and the I2C interface module is connected to the plurality of functional modules, characterized in that:
The I2C master controller initiates an I2C write operation to send a write command packet to the I2C interface module, and then initiates a subsequent I2C read operation to read status information;
after receiving the address byte of the subsequent I2C read operation, the I2C interface module pulls down the level of the I2C clock line and sends the received write command packet to one or more functional modules;
the functional modules that receive the write command packet execute one or more write commands contained in the write command packet and return a write status packet to the I2C interface module, including:
if the execution result of each write command contained in the write command packet is successful, the functional module returns a write status packet with successful status information to the I2C interface module;
if the execution result of at least one write command contained in the write command packet is failed, the functional module returns a write status packet with failed status information to the I2C interface module;
after receiving the write status packet from each functional module to which it sent the write command packet, the I2C interface module stops pulling down the level of the I2C clock line and returns the status information of the write status packet to the I2C master controller.
